(19) United States
(12) Patent Application Publication
(10) Pub. No.: US 2016/0290579 A1
(43) Pub. Date: Oct. 6, 2016

(54) ELECTRIC CANDLE

(71) Applicants: Billy Au, Hong Kong (CN); Chan Wa, Hong Kong (CN)

(72) Inventors: Billy Au, Hong Kong (CN); Chan Wa, Hong Kong (CN)

(21) Appl. No.: 14/846,950

(22) Filed: Sep. 7, 2015

Related U.S. Application Data
(60) Provisional application No. 62/141,849, filed on Apr. 1, 2015.

(51) Int. Cl. F21S 10/04; F21V 23/00; F21S 9/02; F21V 23/04; F21S 6/00; F21V 7/00

(52) U.S. Cl. CPC F21S 10/046; F21S 6/001; F21V 7/00; F21S 9/02; F21V 23/04; F21V 23/003; F21W 2121/00

(57) ABSTRACT

A system is provided having a spring, a suspended leaf, and a motor attached to the spring and causes the spring to rotate. One end of the spring that is not attached to the motor at least temporarily contacts the leaf. The spinning of the spring causes the leaf to rock from side to side and sway and/or swing back and forth. As the leaf rocks and sways, the leaf is illuminated and appears as a randomly flickering flame.

### CROSS-REFERENCE TO RELATED APPLICATIONS

This application claims priority benefit of U.S. Provisional Patent Application No. 62/141,849 (Docket # C7-1), entitled, “ELECTRIC CANDLE,” filed Apr. 1, 2015, by Billy Au, which is incorporated herein by reference.

### FIELD

This specification generally relates to electric candles.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Lights shaped like candles tend to look very unrealistic.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A shows an embodiment of an inner housing of an electric candle;

FIG. 1B shows another view of an embodiment of the electric candle of FIG. 1A;

FIG. 1C shows another embodiment of the inner housing of FIG. 1A;

FIG. 1D shows another view of an embodiment of the inner housing of FIG. 1C;

FIG. 2A shows an embodiment of a fully assembled electric candle;

FIG. 2B shows a bottom view of an embodiment of the outer housing of FIG. 2A;

FIG. 2C shows a cross sectional side view of an embodiment of the outer housing of FIG. 2A;

FIG. 3A shows an exploded view of an embodiment of a portion of the assembly within the inner housing;

FIG. 3B shows an embodiment of the portion of the assembly of FIG. 3A;

FIG. 3C shows a cross section of an embodiment of the upper portion of the leaf of FIG. 1A;

FIG. 3D shows a back view of an embodiment of the upper portion of the leaf of FIG. 1A;

FIG. 3E shows a cross section of an embodiment of a portion of the electric candle of FIG. 1A;

FIG. 4A shows a cross sectional view of an embodiment of the electric candle without the outer housing;

FIGS. 4B and 4C show cross sectional side view of an embodiment of the electric candle without the outer housing;

FIG. 5A shows an embodiment of the battery holder of FIG. 1A;

FIG. 5B shows a bottom view of an embodiment of the battery holder with the batteries placed inside the battery holder;

FIGS. 5C and 5D show different views of an embodiment of the door having conductors;

FIG. 5E shows a view of an embodiment of the other side of the door of FIG. 5C;

FIGS. 6A-6C show different views of an embodiment of the motor that sits on top of the battery holder;

FIGS. 7A and 7B show different views of an embodiment of the cover that sits on top of the battery holder covering the motor;

FIGS. 8A-D show different views of an embodiment of the translucent leaf that sits in the carriage.

FIG. 9 shows a diagram of an embodiment of the circuit that controls the light and motor;

FIG. 10 shows a diagram of another embodiment of the circuit of FIG. 9;

FIG. 11 is a flowchart of an embodiment of a method of using the electric candle;

FIG. 12 is a flowchart of an embodiment of a method of assembling the electric candle;

FIGS. 13A-F shows different views of an embodiment of the electric candle; and

FIGS. 14A-F shows different views of another embodiment of the electric candle.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

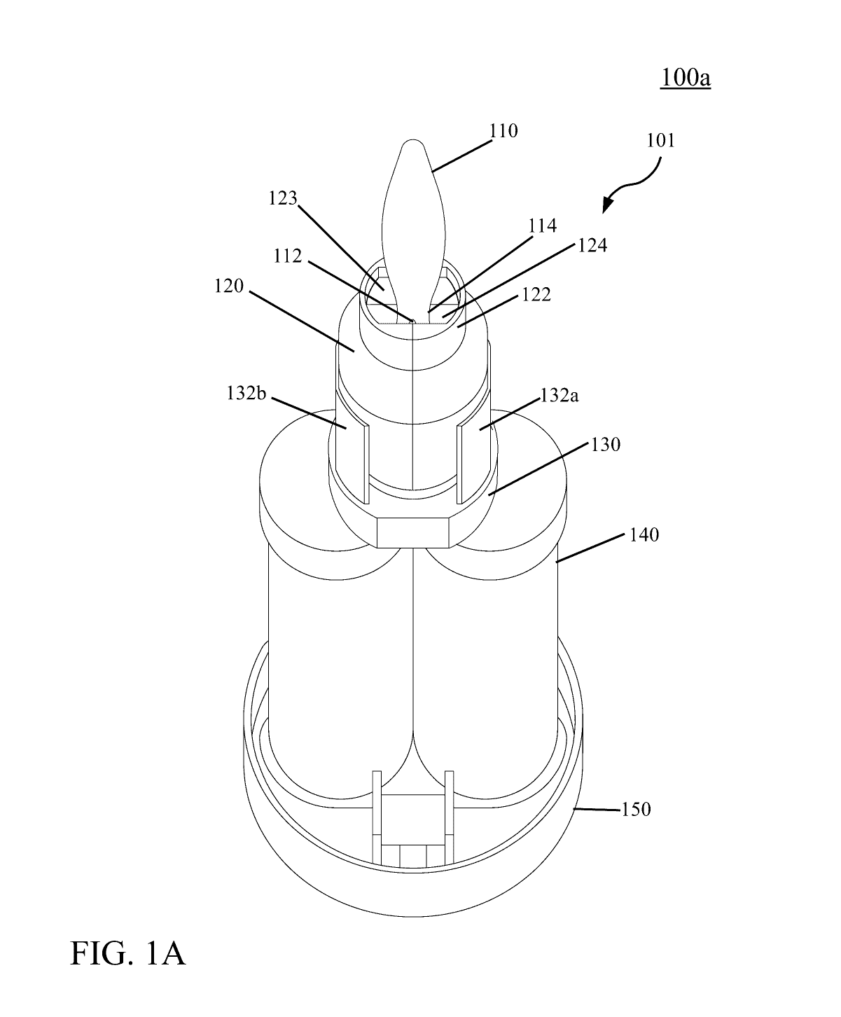

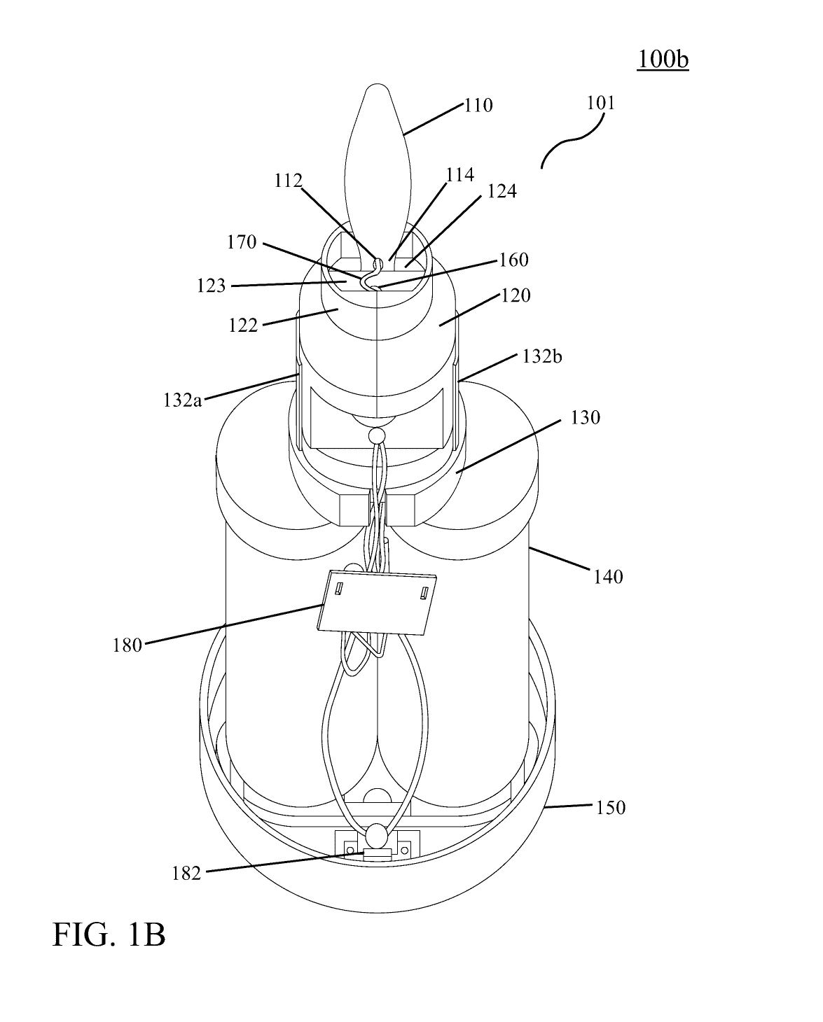

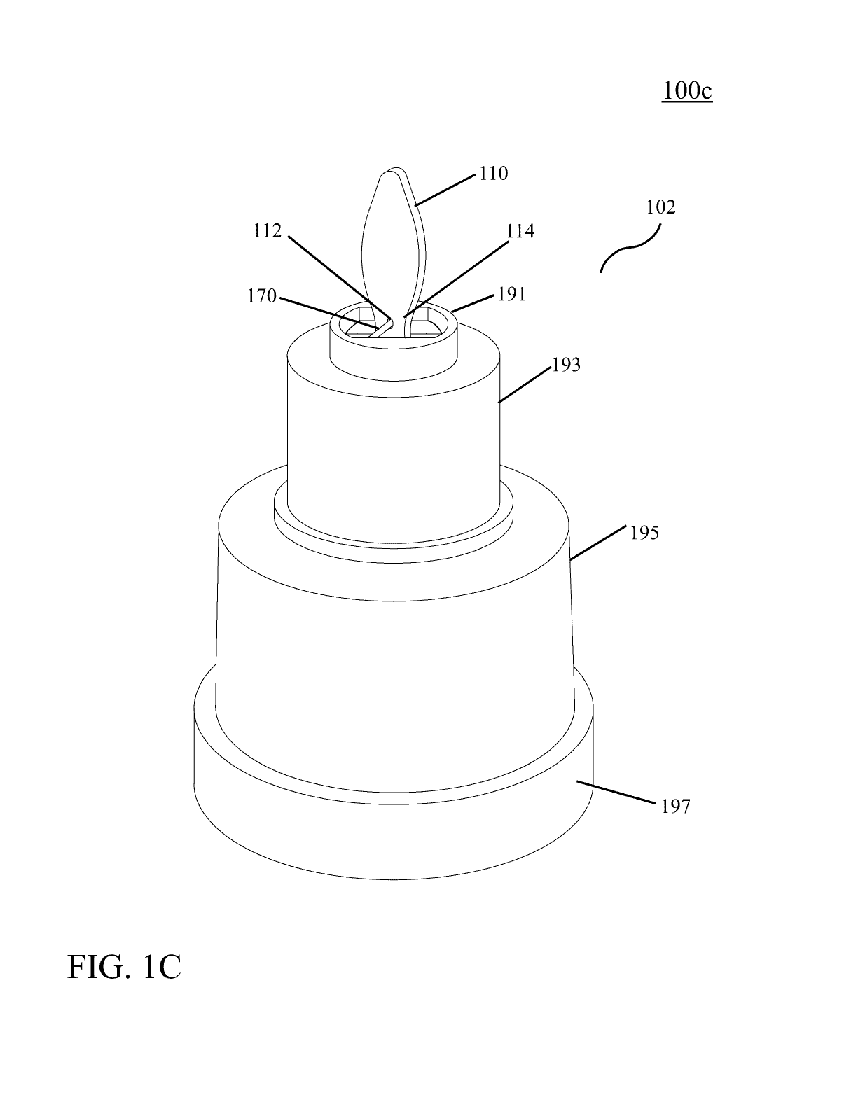

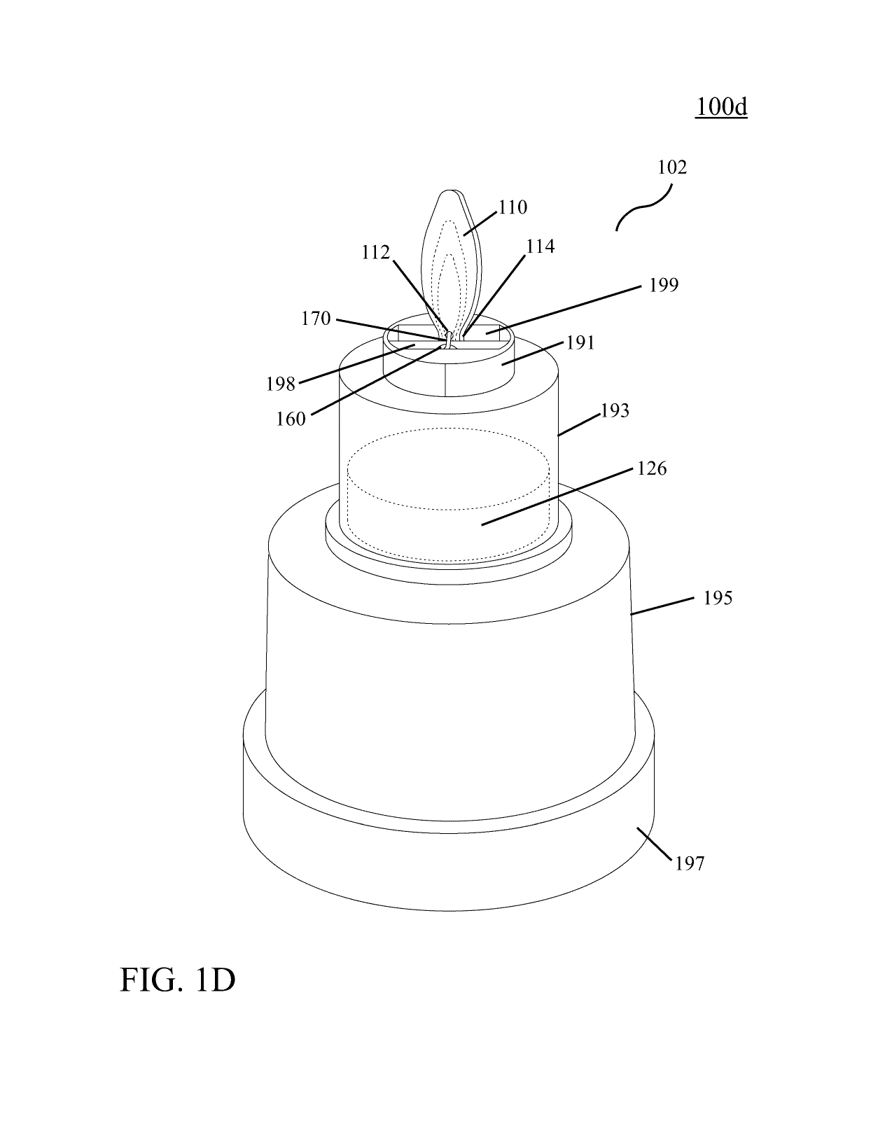

In general, at the beginning of the discussion of each of FIGS. 1A-8D is a brief description of each element, which may have no more than the name of each of the elements in the one of FIGS. 1A-8D that is being discussed. After the brief description of each element, each element is further discussed in numerical order. In general, each of FIGS. 1A-12 is discussed in numerical order and the elements within FIGS. 1A-12 are also usually discussed in numerical order to facilitate easily locating the discussion of a particular element. Nonetheless, there is no one location where all of the information of any element of FIGS. 1A-12 is necessarily located. Unique information about any particular element or any other aspect of any of FIGS. 1A-12 may be found in, or implied by, any part of the specification.

FIG. 1A shows an embodiment of an inner housing 101 of an electric candle 100a. The electric candle 100a includes at least inner housing 101, a leaf 110, a hole 112, a base portion 114, a carriage 120, a collar 122, a covering 123, an opening 124, a cover 130, flanges 312a and 132b, a battery holder 140, and a base 150. In other embodiments, inner housing 101 of the electric candle 100a may not have all of the elements or features listed and/or may have other elements or features instead of or in addition to those listed.

Electric candle 100a includes an electric light that looks like a candle with a simulated flame that looks realistic when turned on and viewed from a slight distance. A translucent leaf that is shaped like a flame sticks out the top of the electric candle 100a where the wick would be were the electric candle real.

Inner housing 101 is a structure that houses and retains the electrical and mechanical components that move and illuminates the translucent leaf when the electric candle 100a is turned on. In at least one embodiment, inner housing 101 fits into an outer housing that resembles a partially used candle. Alternatively or additionally, inner housing 101 may include other components and/or structures.

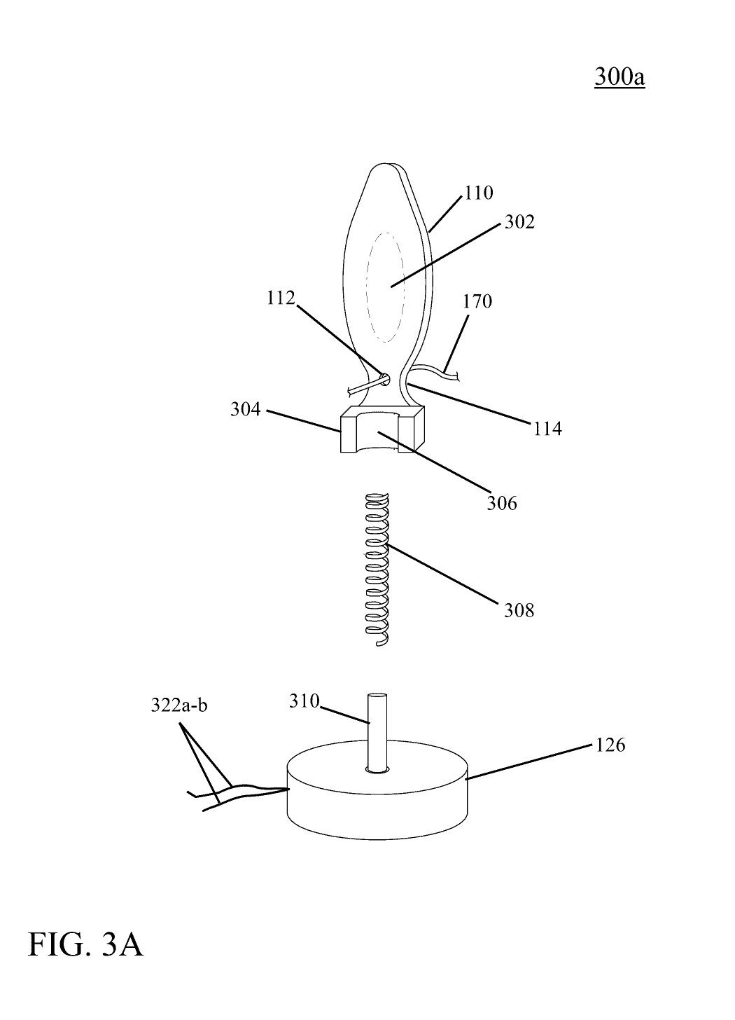

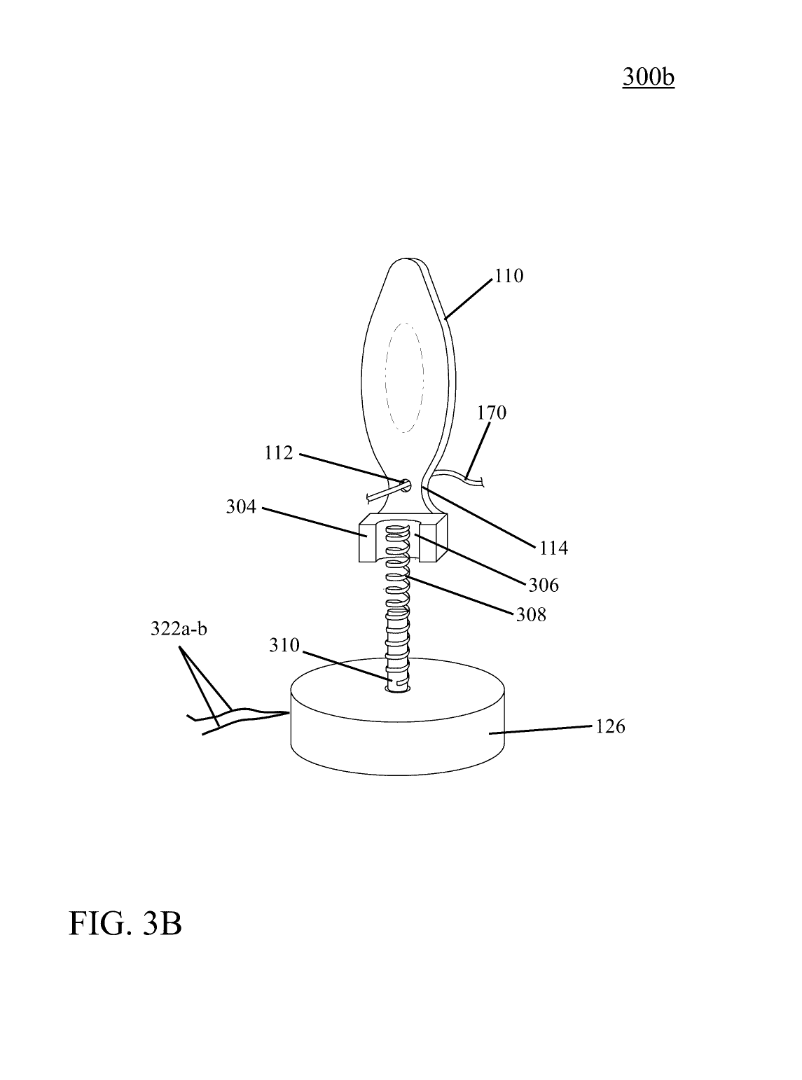

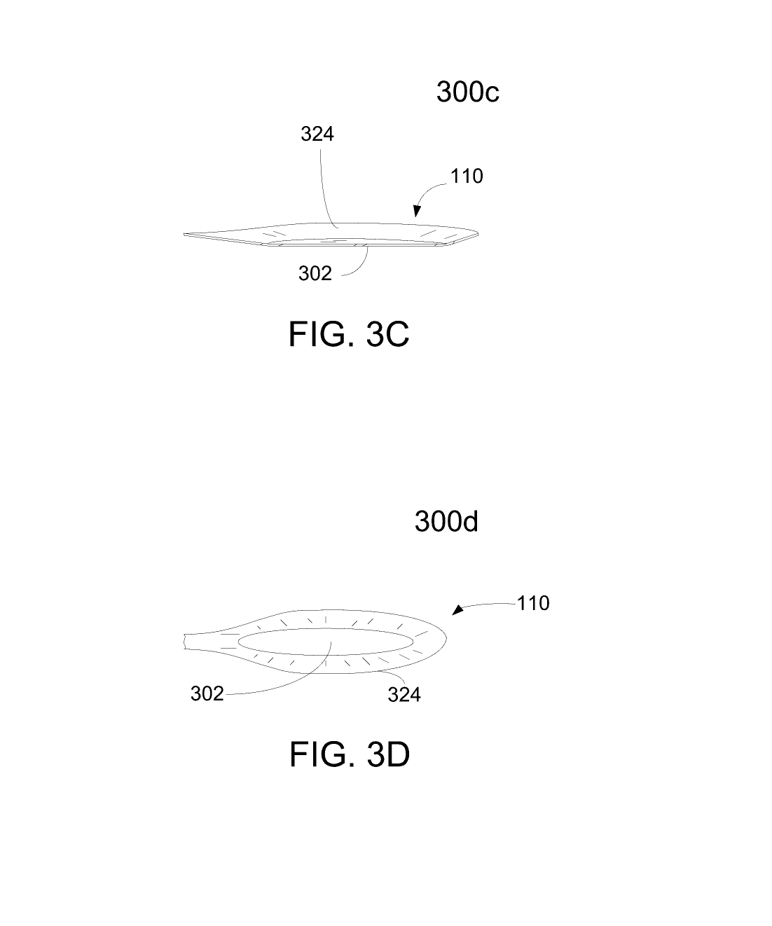

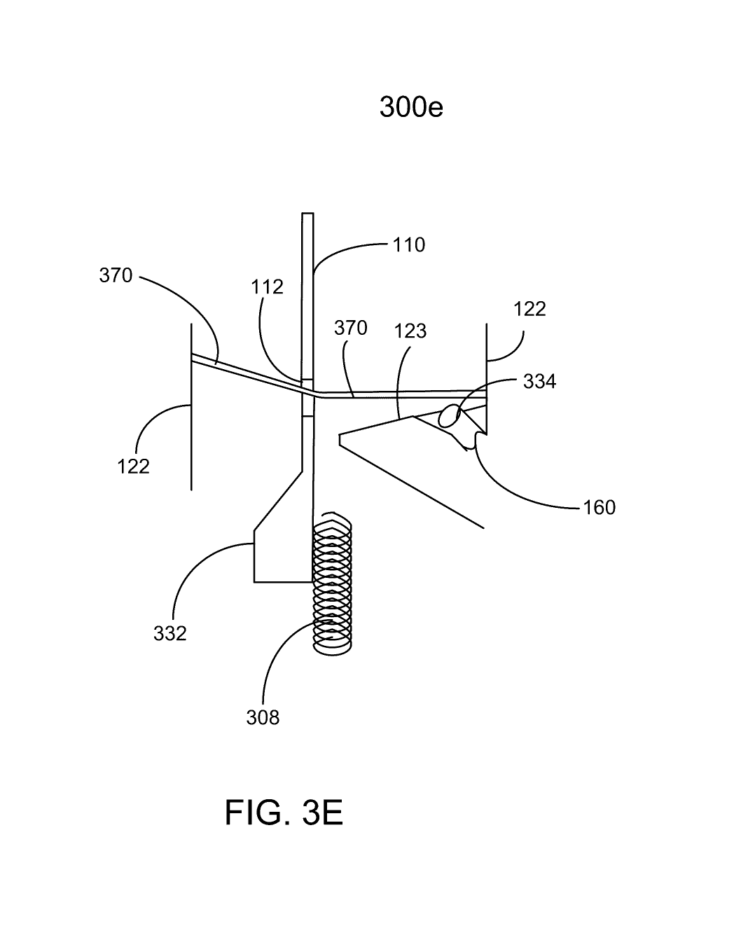

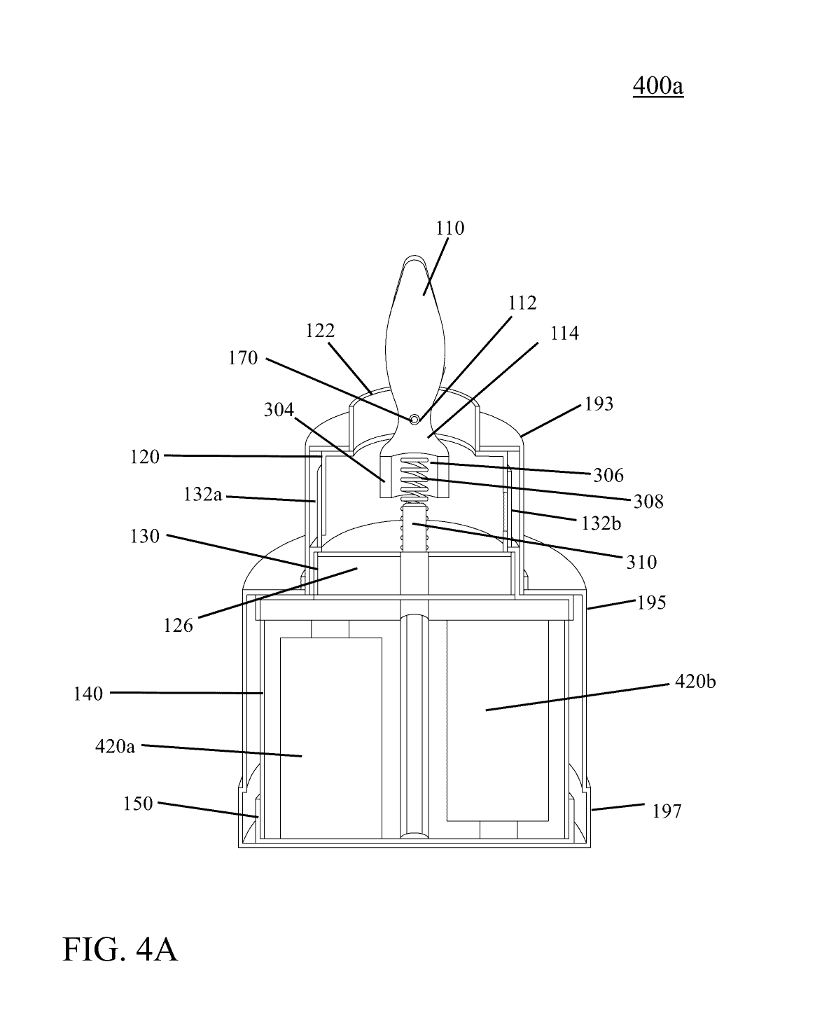

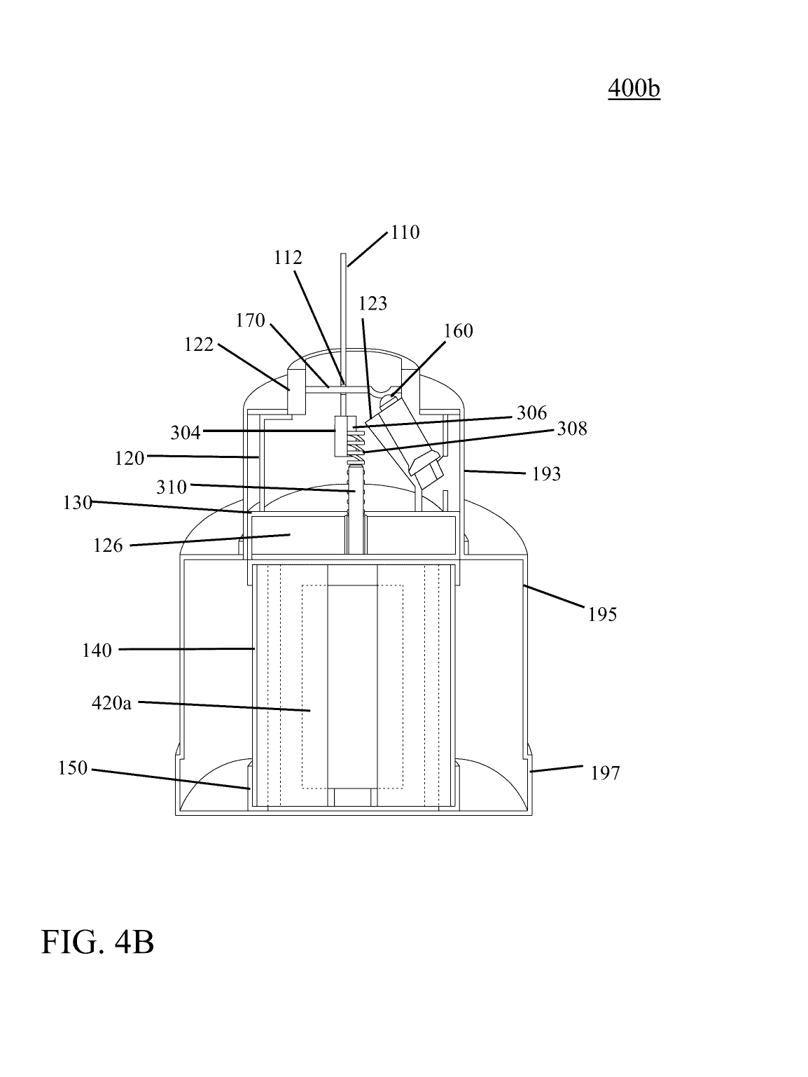

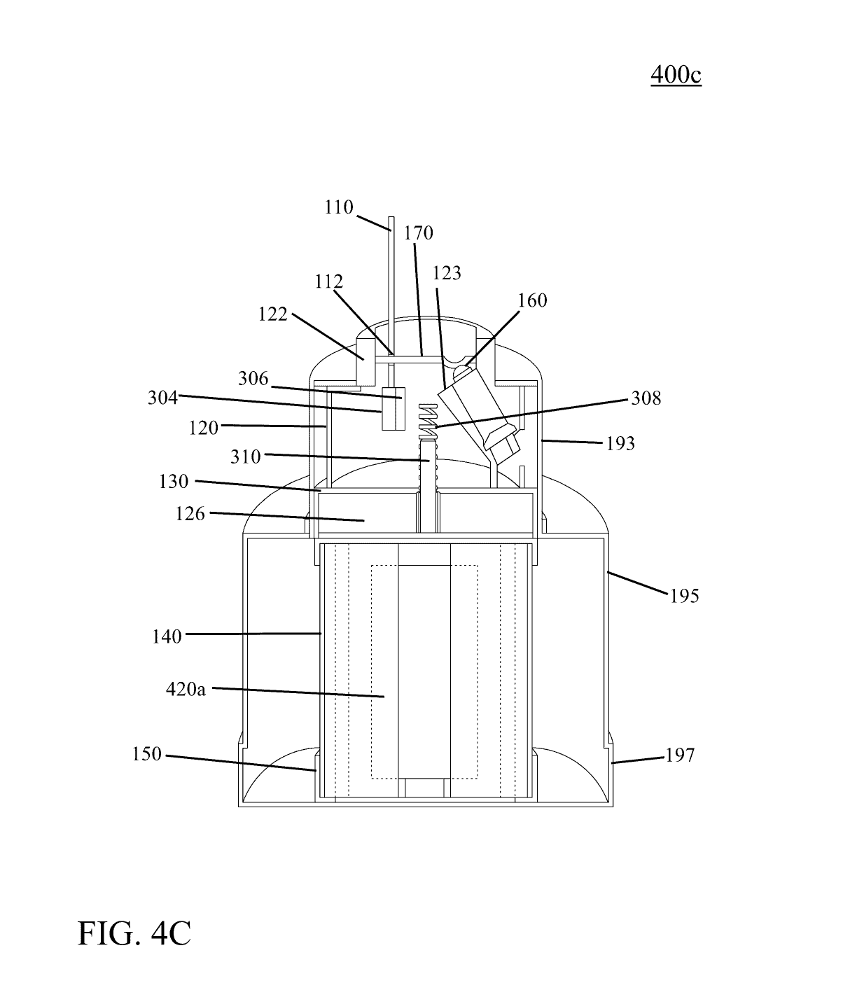

Leaf 110 is shaped like a flame, and is mounted on inner housing 101, so as to stick out the top of the inner housing 101 of the electric candle 100a. In at least one embodiment, leaf 110 is a leaf-shaped thin plate. In an embodiment, leaf 110 is made of translucent material such as translucent plastic. In an embodiment, a tip of the leaf 110 points approximately upwards and a base portion of the leaf 110 is suspended (e.g. on a wire or rod) in a manner that the leaf 110 is free to slide back and forth from side to side about an axis that is perpendicular to the face of the leaf 110. In an embodiment, FIG. 1A shows a front side of the leaf 110, while the back side of the translucent leaf is illuminated by a light source that is behind the leaf 110 when the light source is on. In an embodiment, the leaf 110 has a white color. In other embodiments, leaf 110 may have other colorings that resemble flames. For example, leaf 110 may have a slight yellow tint. In at least one embodiment, a motor that sits under the cover may rotate and cause the leaf 110 to vibrate when the electricity is provided. The components inside inner housing 101 will be discussed in conjunction with the description of FIGS. 3A, 3B, 4A, and 4B.

Hole 112 is a hole at the base portion of the leaf 110, through which a wire goes to suspend the leaf 110 in a collar on the top of the carriage, while the leaf 110 sticks out the collar. In this specification, although the word “wire” is used to describe the wire that goes thought hole 112, any of a number of other elongated pieces of material may be substituted instead of a wire to obtain other embodiments. For example, wherever the word wire is mentioned, the wire may be replaced with a rod, a pin, or a string to obtain other embodiments. In at least one embodiment, the diameter of the hole 112 is slightly greater than the diameter of the wire that goes through the hole 112, so as to allow the leaf 110 to slide, swivel, and rock freely on the wire.

Base portion 114 is a portion at the base of the leaf 110. In at least one embodiment, the base portion 114 sits in an opening inside the collar while the leaf 110 is suspended on the wire. In at least one embodiment, the base portion 114 is narrower than the leaf 110 at the widest point.

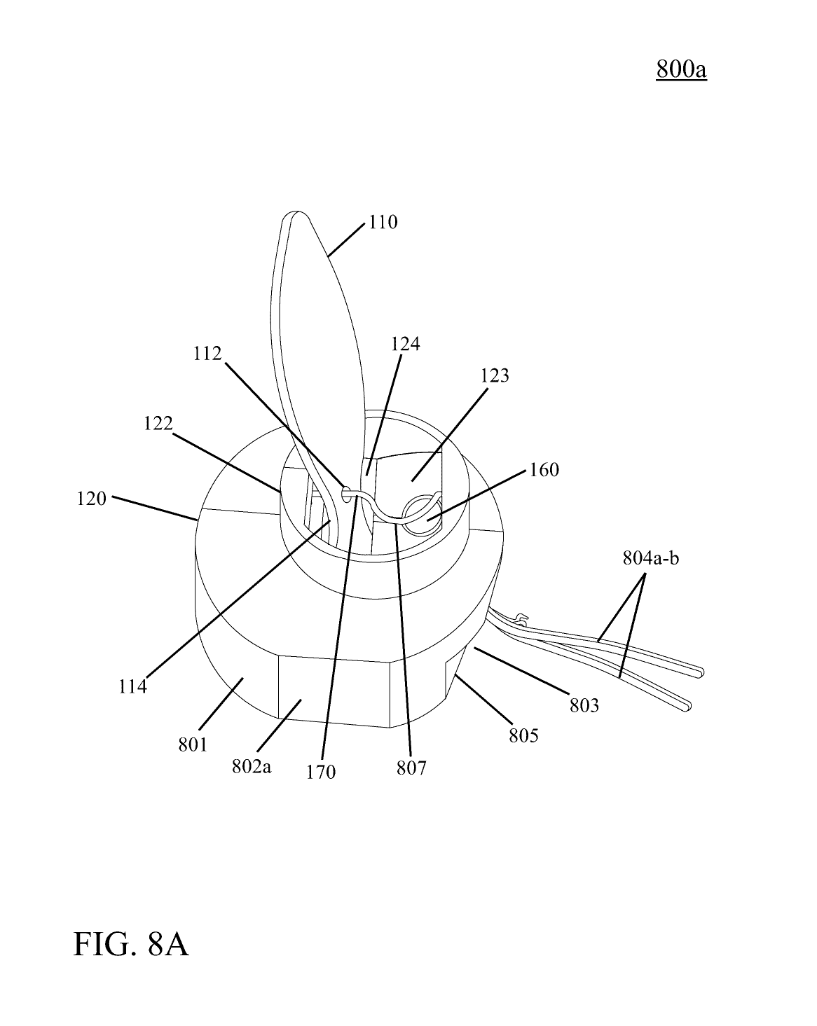

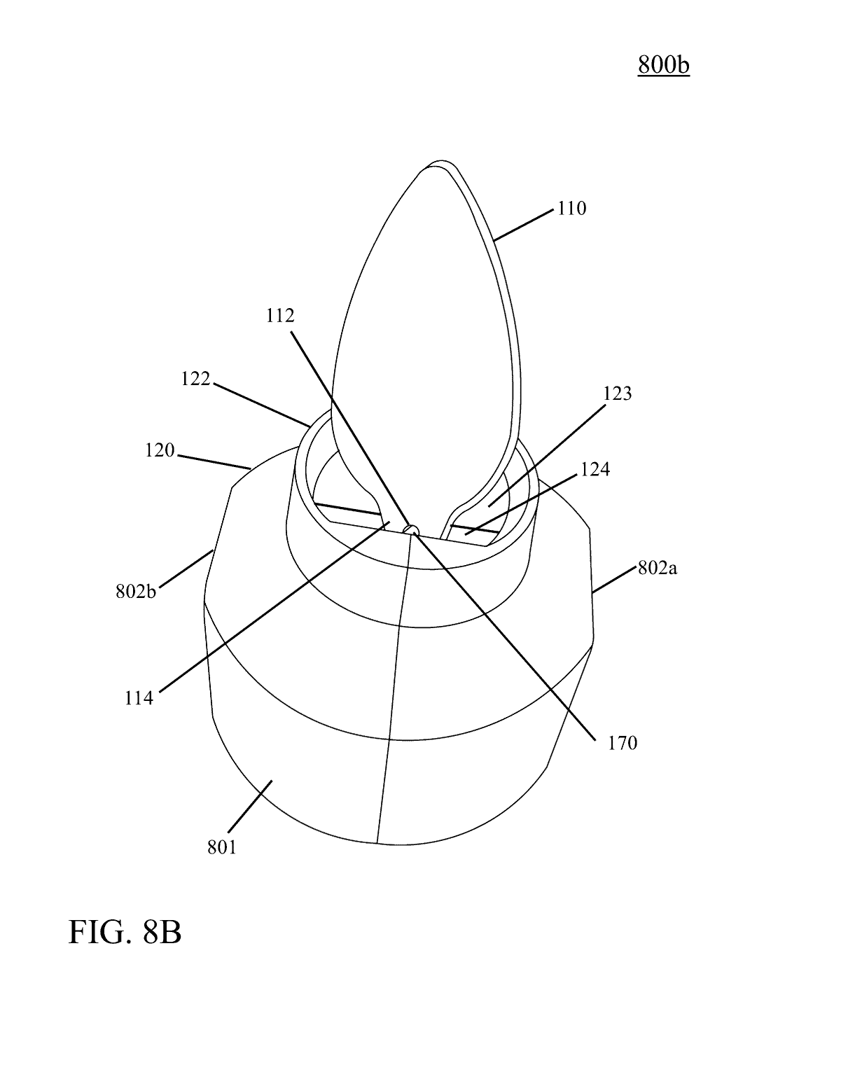

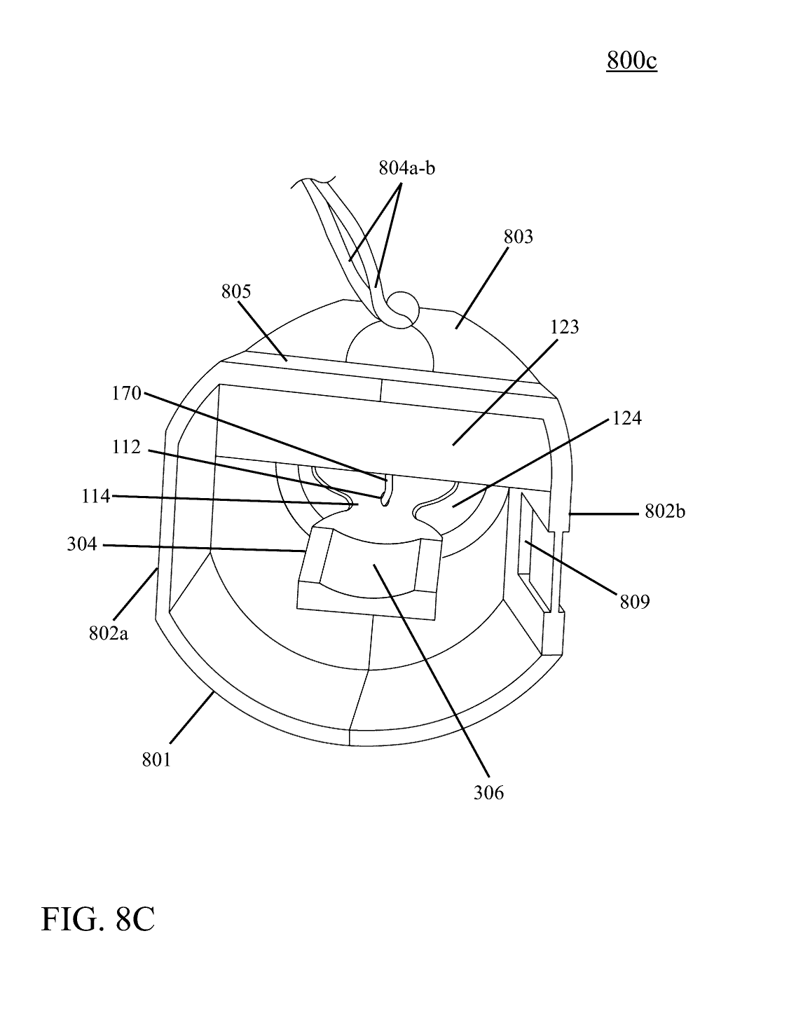

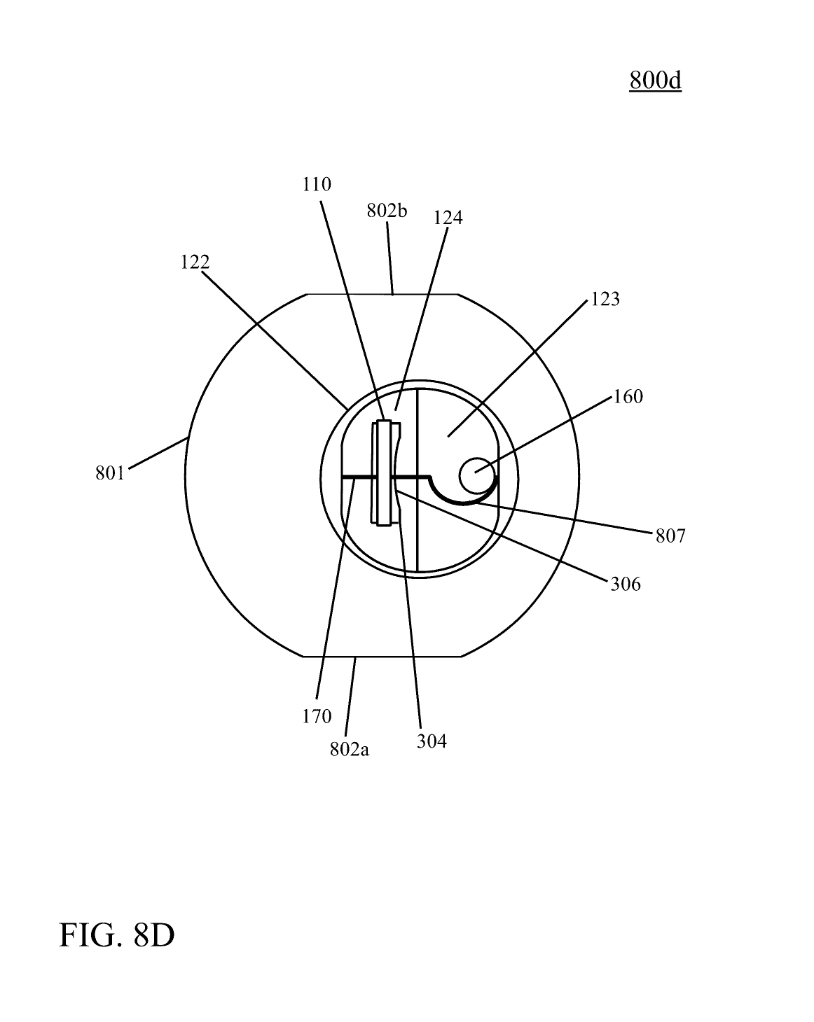

Carriage 120 is a structure in which the leaf 110 sits. In an embodiment, the carriage 120 may be formed by connecting two half pieces together. Alternatively or additionally, the carriage 120 may include other structures and/or shapes. Carriage 120 will be discussed in conjunction with the description of FIGS. 8A-8D.

Collar 122 protrudes from the top of the carriage 120, in which the leaf 110 is suspended on the wire that is mounted to the wall from inside of the collar 122. Alternatively or additionally, the collar 122 may include other structures and/or shapes.

Covering 123 is a structure located inside the collar 122, leaving an opening in the collar 122 that is not blocked by the covering 123. In an embodiment, the covering 123 takes less than half of the area outlined by the collar 122. In another embodiment, the covering 123 takes equal to or more than half of the area outlined by the collar 122. In at least one embodiment, the top surface of the covering 123 is slightly tilted facing the leaf 110. In an embodiment, the covering 123 is located behind the leaf 110.

Opening 124 is the opening inside the collar 122 that is not blocked by the covering 123. In at least one embodiment, the width and length of the opening 124 are larger than the width and thickness of the base portion 114 of the leaf 110, respectively, allowing the leaf 110 to move back and forth and from side to side in the opening 124.

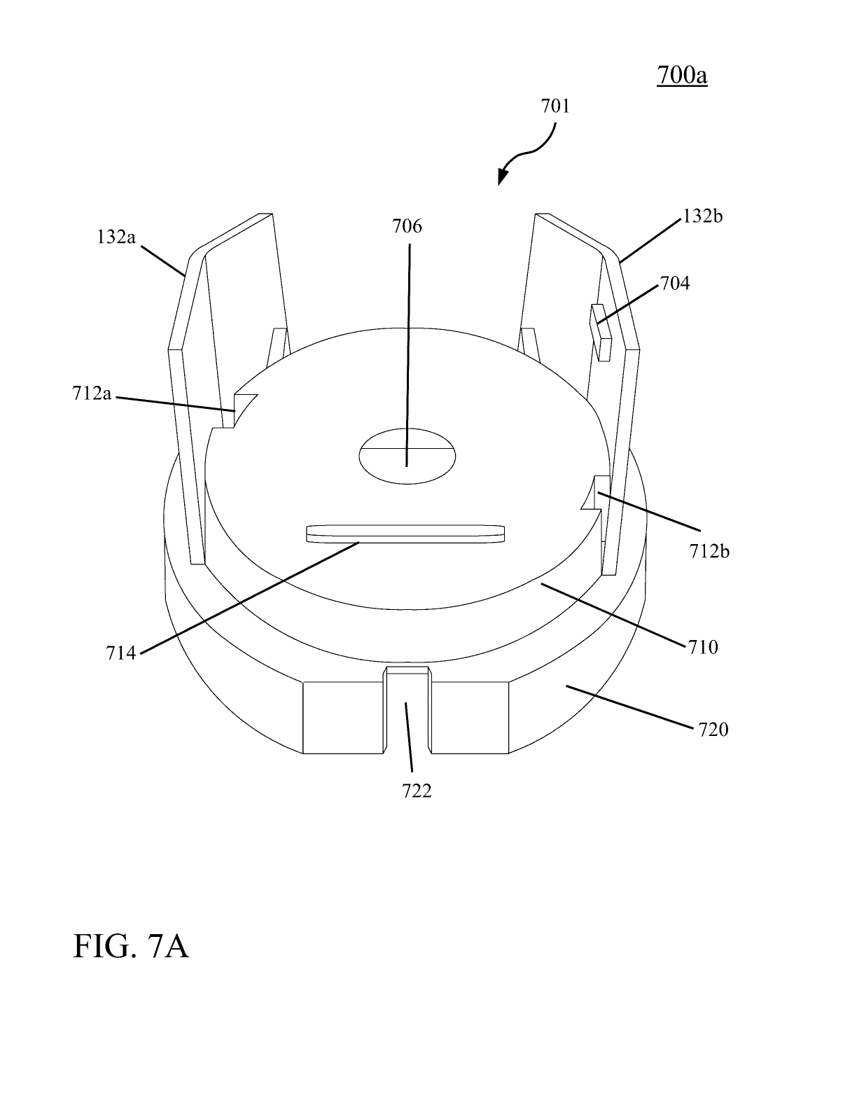

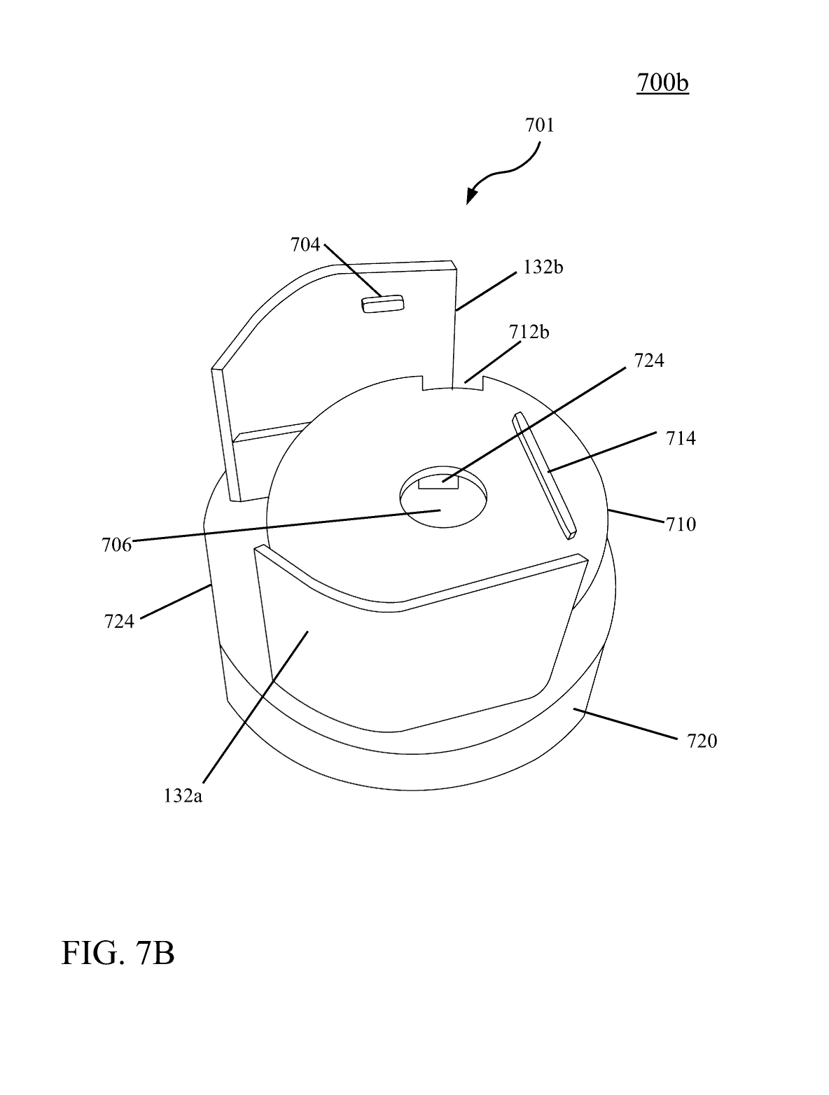

Cover 130 is a structure that covers the motor and connects the carriage 120 to the top of the battery holder. In at least one embodiment, the cover 130 includes two flanges protruding from the top of cover 130 that include tabs or protrusions to engage the hole or detent on the carriage 120. Alternatively or additionally, the cover 130 may include other structures to connect to the carriage 120. In at least one embodiment, the cover 130 includes a hole at the top, through which a shaft of the motor sticks out. In an embodiment, the cover 130 may include tabs or other structures from the inside under the cover 130 to hold the motor in place. Further details of the cover 130 will be discussed in conjunction with the description of FIGS. 7A and 7B.

Flanges 132a and 132b extend upward from the cover 130 for engaging the carriage 120 in which the leaf 110 sits. In an embodiment, flanges 132a and 132b may include one or more detents and/or protrusions to engage complementary structures on the carriage 120.

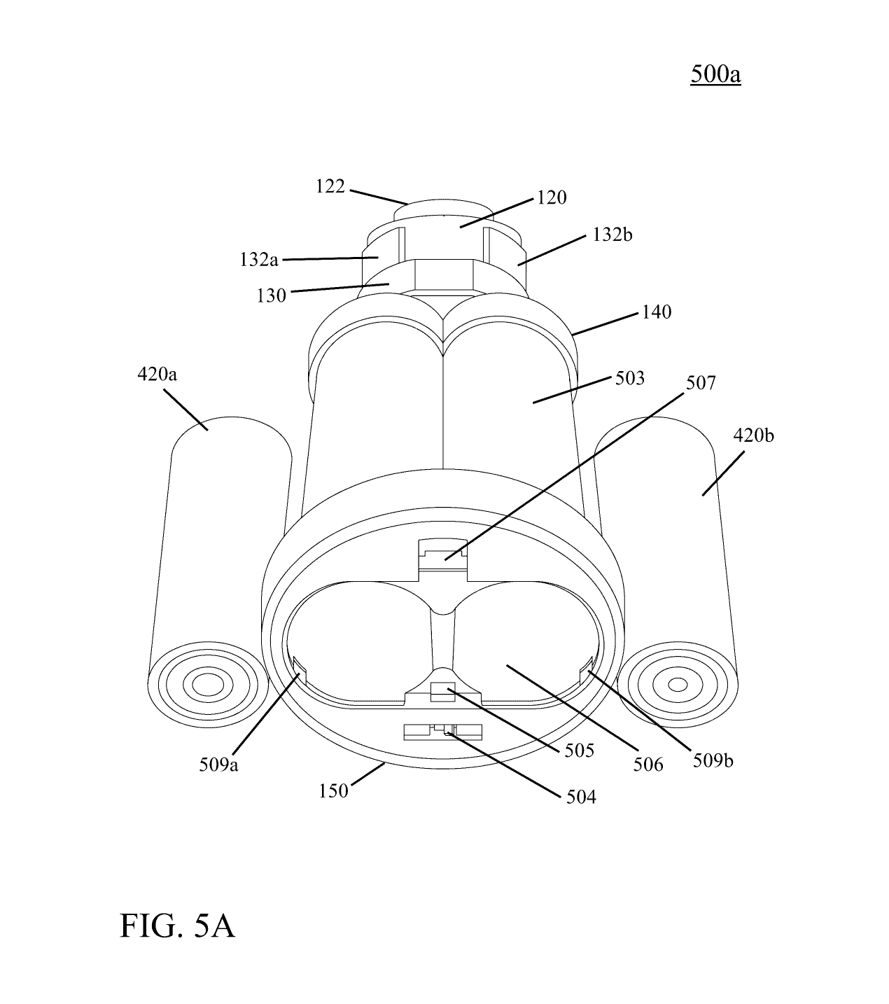

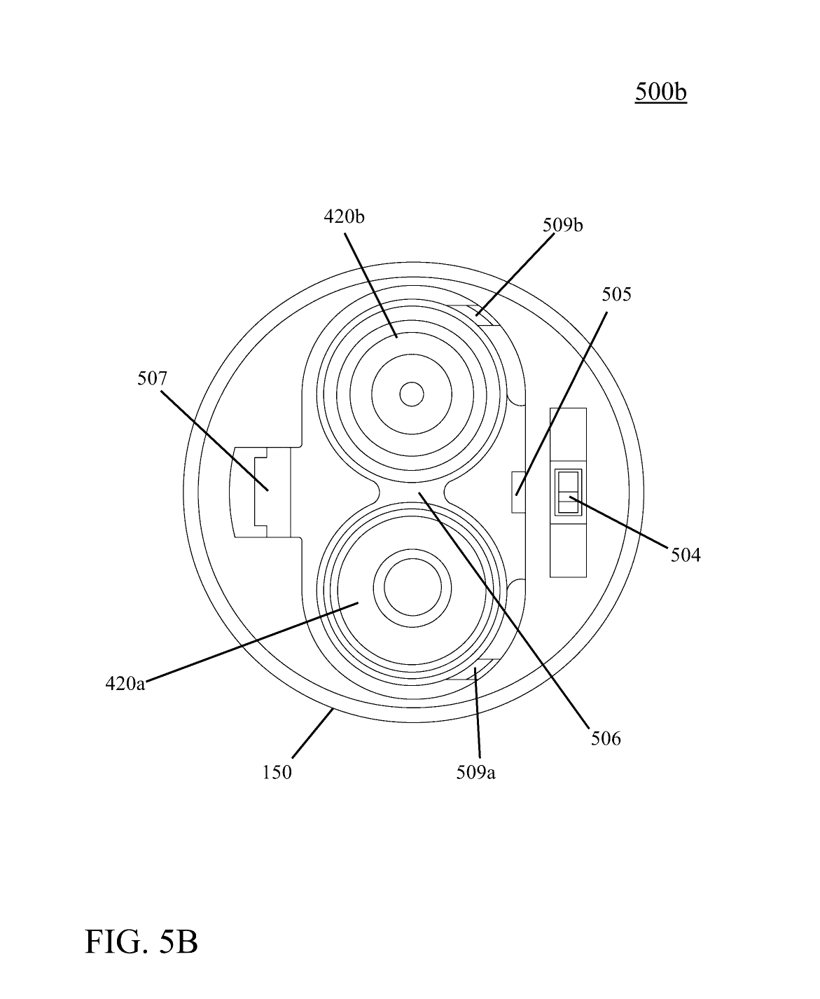

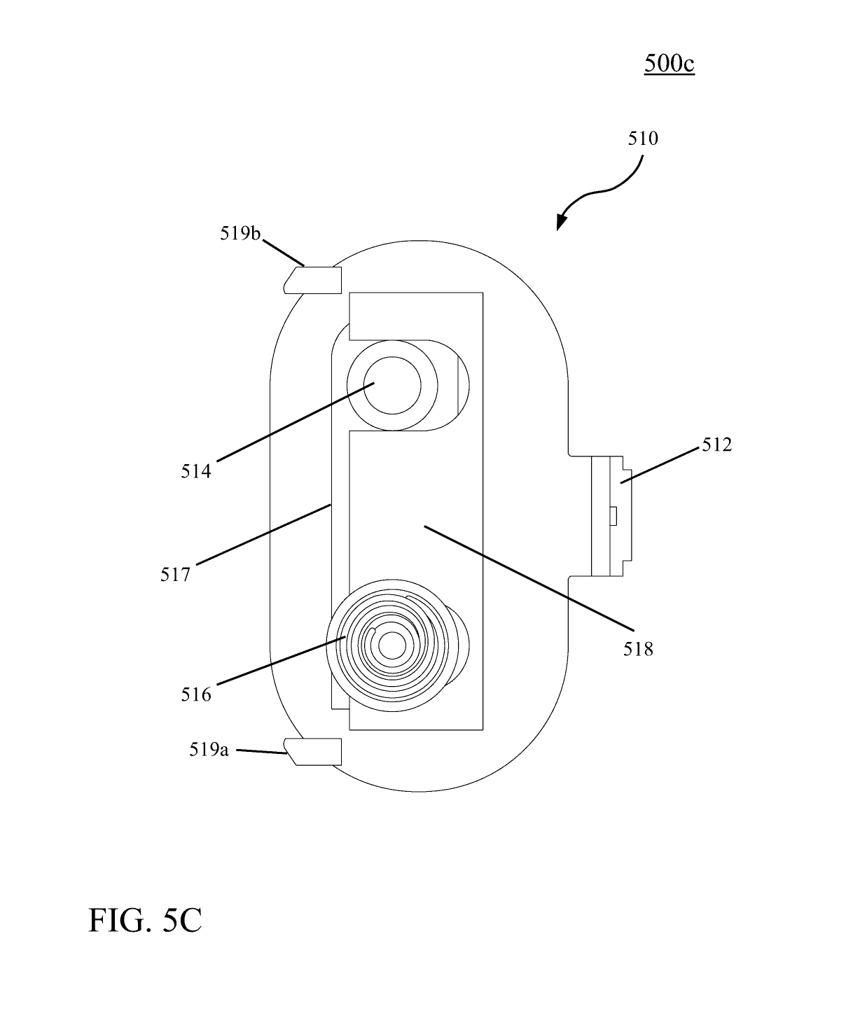

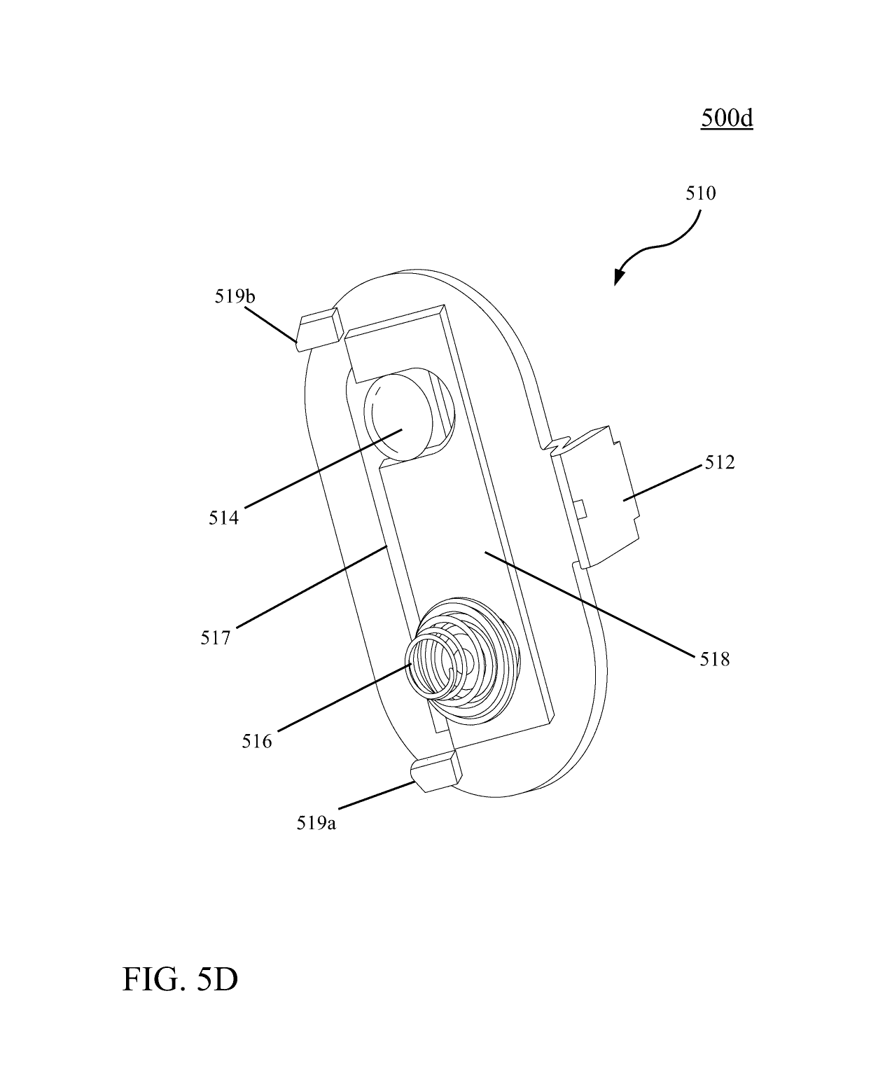

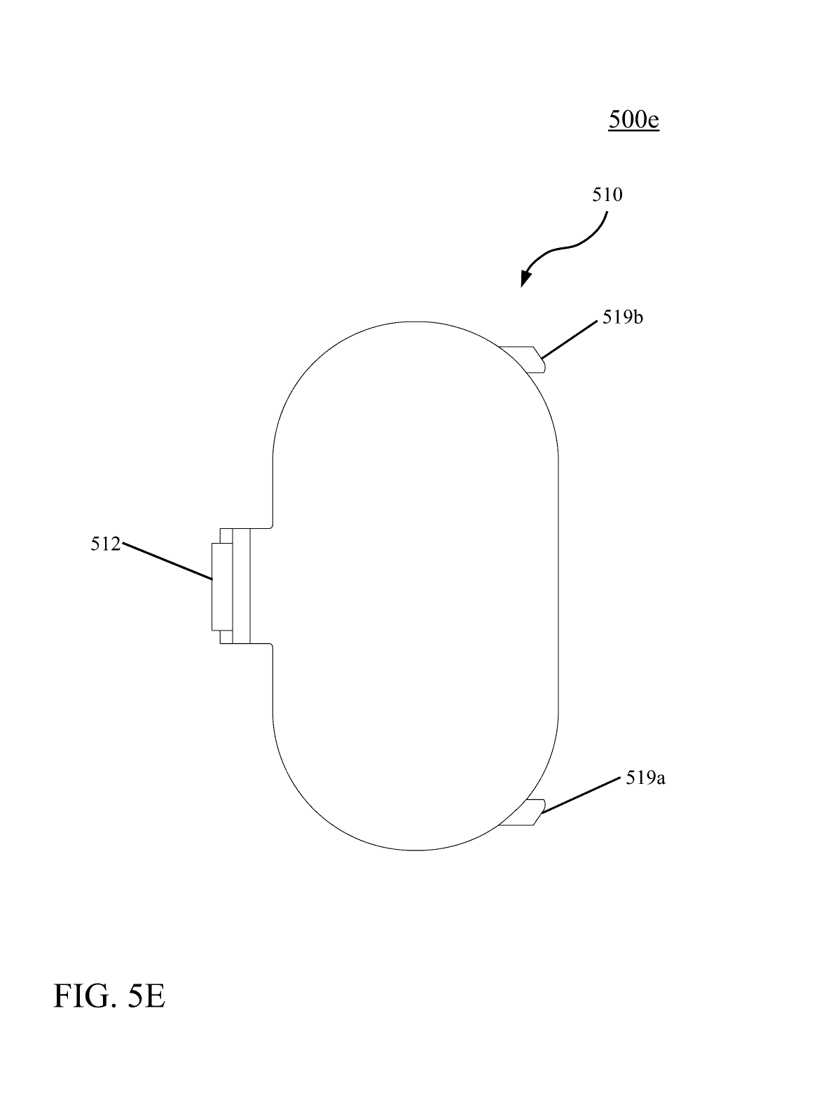

Battery holder 140 is a structure that holds one or more batteries, while keeping the electrical leads of the battery holder 140 in electrical contact with the battery terminals. In at least one embodiment, battery holder 140 is a casing or chamber that accepts one or more batteries and has a door or lid to retain and protect the batteries. In an embodiment, battery holder 140 includes a double barrel chamber for holding two batteries. In other embodiments, battery holder 140 may include other structures and/or shapes, and may hold other numbers of batteries. In an embodiment, battery holder 140 may include built-in rechargeable batteries and/or power cords for connecting to a power outlet. In an embodiment, battery holder 140 includes electrical wires that connect the electric connections in the battery holder 140 to the motor, light source, and/or a circuit board of the electric candle 100a. In an embodiment, the cover 130 is connected to the top of the battery holder 140. In an embodiment, the term “battery holder” and “battery casing” are used interchangeably and either term may be substituted for the other to obtain different embodiments. Battery holder 140 will be discussed in conjunction with the description of FIGS. 5A-5E.

Base 150 is the base of the battery holder 140. Base 150 supports the assembly above the base 150, so the assembly stands without falling. In an embodiment, base 150 has a larger diameter than those portions of the electric candle 100a that sit on top of base 150.

FIG. 1B shows another view 100b of an embodiment of the electric candle 100a of FIG. 1A. FIG. 1B shows at least leaf 110, hole 112, base portion 114, carriage 120, collar 122, covering 123, opening 124, cover 130, flanges 312a and 132b, battery holder 140, and base 150. FIG. 1B further includes a light 160, a wire 170, a circuit 180, and a switch 182. In other embodiments, the assembly in view 100b may not have all of the elements or features listed and/or may have other elements or features instead of or in addition to those listed.

FIG. 1B shows the components at the back side of the inner housing 101 of the electric candle 100a of FIG. 1A. The leaf 110 sits in an opening inside the collar 122 that is not covered. A light is located on a covering behind the leaf 110 and may shine on the back side of the leaf 110. FIG. 1B also shows a circuit board that controls the on-and-off of the electric candle 100a.

Light 160 is a light source that is installed on the covering 123, behind the leaf 110. In at least one embodiment, the light 160 is installed facing the leaf 110. In at least one embodiment, the top surface of the covering 123 may help to reflect light from light 160 towards the back of the leaf 110 as the leaf 110 slightly slide back and forth and rock from side to side. In at least one embodiment, light 160, when turned on, shines on the back of the leaf 110 as the leaf 110 rocks and slides back and forth, appearing like a flame. In an embodiment, light 160 is a light emitting diode (LED) light that includes one or more diodes. Optionally, the light 160 has a yellowish color, similar to that of a flame. In other embodiments, the light 160 could be another type of light, such as an incandescent bulb, an iridescent bulb, or another light source. In an embodiment, light 160 illuminates the leaf 110 as well as a top part of the electric candle 100a. In an embodiment, electric candle 100a may include more than one light 160.

Wire 170 is a metal wire or metal rod that is inserted through the hole 112 to suspend the leaf 110 in the collar 122 in a manner that the leaf 110 is free to slide back and forth on the wire 170 and rock from side to side about the axis formed by the wire 170. In at least one embodiment, the wire 170 is at an angle from perpendicular to the surface of the leaf 110. In an embodiment, the wire 170 is mounted to the wall from inside of the collar 122. In an embodiment, the wire 170 is mounted above the opening in the collar 122, while the leaf 110 moves in the opening. In other embodiments, the wire 170 may be mounted at the same level of or slightly below the opening inside the collar 122. In an embodiment, a portion of the wire 170 above the light source is curved to one side of the light source so as not to block the light shining on the leaf 110.

Circuit 180 may include a circuit board and/or a controller that controls the electricity supplied to the motor and the light 160 of the electric candle 100a. In at least one embodiment, the circuit 180 is connected via electrical wires to the light 160, a motor, the battery holder 140, and a switch at the bottom of the base 150. In at least one embodiment, the circuit 180 may include a control circuit and/or a clock for periodically turning the electric candle 100a on and off on a regular schedule or based on various settings. For example, the electric candle 100a may automatically and repeatedly light up for 6 hours, then automatically shut off for 18 hours, then turn on again for another 6 hours, and then shut off for another 18 hours, etc. Alternatively or additionally, the circuit 180 may control an electrical switch that turns on and shuts off electricity supplied to the motor and/or light 160.

Switch 182 is an electrical component that allows a user to manually turn on and off the electric candle 100a by making or breaking an electrical connection from the batteries to the rest of the electric candle 100a. In an embodiment, switch 182 is a slide switch located at the bottom of the base 150. In at least one embodiment, switch 182 includes a slider that can be pushed to stop at two positions, in which the electric candle 100a is either turned on or off. In other embodiments, switch 182 may be a push button, toggle, rotary selector switch, or any other switch. In at least one embodiment, switch 182 is connected to the circuit 180 that further controls the electricity flow to the motor and the light 160.

FIG. 1C shows another embodiment of the electric candle 100a of FIG. 1A. Inner housing 102 includes at least leaf 110, hole 112, base portion 114, and wire 170. Inner housing 102 further includes a collar 191, a top housing 193, a bottom housing 195, and base 197. In other embodiments, the assembly in view 100c may not have all of the elements or features listed and/or may have other elements or features instead of or in addition to those listed.

FIG. 1C shows a view of another embodiment of electric candle 100a, in which the electrical and/or mechanical components may be enclosed in a structure that is different from the inner housing 101. Instead of using inner housing 101, the carriage 120, cover 130, and battery holder 140 of the inner housing 101 may be fitted inside the inner housing 102.

Collar 191 is similar to the collar 122, except that collar 191 is on the top of a top housing while collar 122 is on the top of the carriage 120. In at least one embodiment, leaf 110 sits in the collar 191 with the wire 170 mounted to the wall inside collar 191. In an embodiment of collar 191 being collar 122, the carriage 120 is inserted inside the top housing while the collar 122 sticks out of an opening on the top of the top housing.

Top housing 193 includes a cylindrical chamber that holds the motor and other components that cause the leaf 110 to move. In another embodiment, top housing 193 covers and retains the carriage 120 and cover 130 of FIG. 1A.

Bottom housing 195 includes a cylindrical housing located under the top housing 193. In at least one embodiment, the bottom housing 195 holds batteries that provide electricity to the motor in the top housing 193. In another embodiment, the bottom housing 195 is a housing in which the battery holder 140 is inserted and connected to the cover 130.

Base 197 is the base of the bottom housing 195 that includes a circular ring structure that may fit inside the bottom part of the outer housing. In an embodiment, the base 197 covers the base 150 of the battery holder 140. In an embodiment, base 197 may include a switch and a door at the bottom side of the base 197.

FIG. 1D shows another view 100d of an embodiment of the inner housing 102 of FIG. 1C. FIG. 1D shows at least leaf 110, hole 112, base portion 114, wire 170, collar 191, top housing 193, bottom housing 195, and base 197. Inner housing 102 further includes a motor 126, a covering 198, an opening 199, and a light 161. In other embodiments, the inner housing 102 of FIG. 1D may not have all of the elements or features listed and/or may have other elements or features instead of or in addition to those listed.

FIG. 1D shows the components at the back side of the inner housing 102. In an embodiment, covering 198, opening 199, and light 161 are similar to covering 123, opening 124, and light 160, respectively, which were discussed in conjunction with FIG. 1B. Covering 198, opening 199, and light 161 are located inside the collar 199 of inner housing 102. Alternatively or additionally, inner housing 102 may include other structures and/or shapes.

Motor 126 is a motor assembly that includes an electric motor enclosed in the inner housing 102. In an embodiment, motor 126 is an electromagnetic motor having coils wrapped around arms of the rotors and/or a stator to create electromagnets that repel one another causing the rotor to rotate about the stator. In an embodiment, all of the magnets of the motor 126 are electromagnets. In another embodiment, some of the magnets are permanent magnets. Motor 126 is an embodiment of the motor that is covered by the cover 130 in the inner housing 101. In at least one embodiment, motor 126 causes the leaf 110 to move and vibrate when electricity is provided. In at least one embodiment, the motor 126 is installed at the bottom of the top housing 193. The motor 126 may be driven by the electricity supplied from the batteries in the bottom housing 195. In an embodiment, the motor 126 was not necessarily built with the intent of having any vibrations, but nonetheless has a slight vibration as the motor 126 operates. Optionally, in an alternative embodiment, an oscillator circuit is attached to the motor 126 to enhance the vibrations of the motor 126. In an embodiment, motor 126 is a direct current (DC) motor of 1.5 volt (V). In another embodiment, motor 126 may be an AC motor. In other embodiments, other types of motor may be used to replace motor 126. Motor 126 will be discussed in conjunction with the description of FIGS. 3A and 3B.

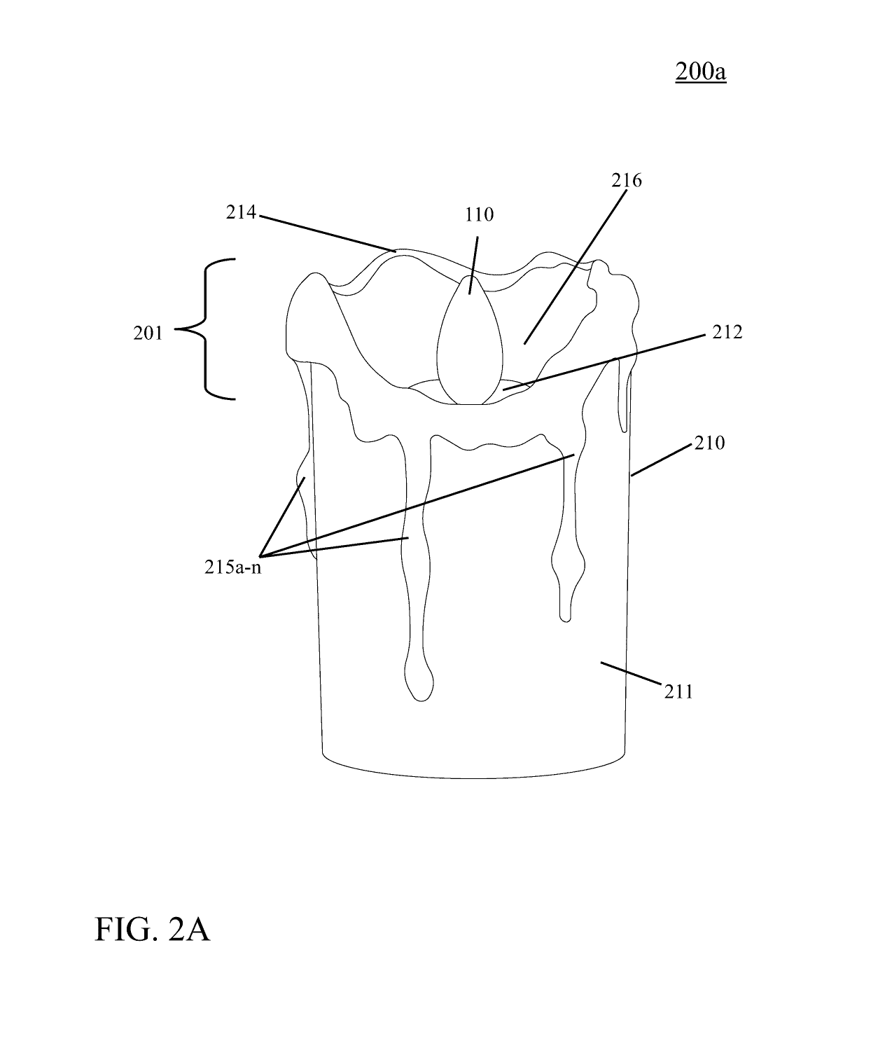

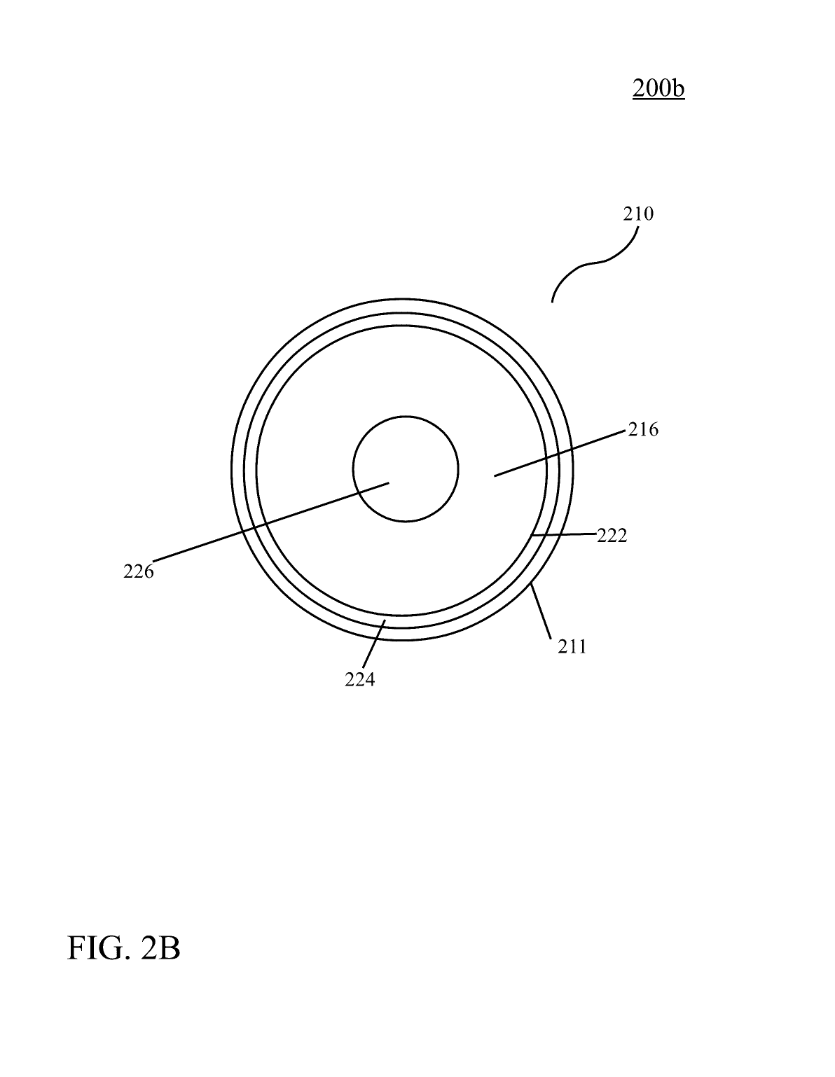

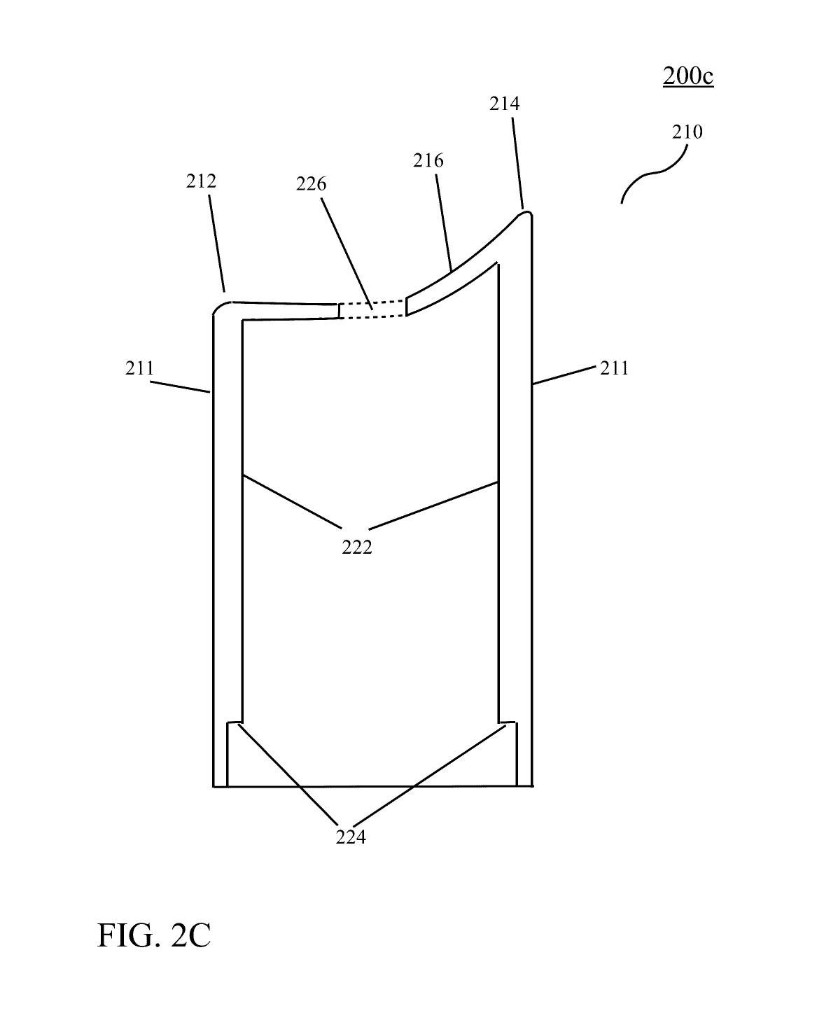

FIG. 2A shows an embodiment of a fully assembled electric candle 200. Electric candle 200 may be an embodiment of the electric candle 100a. Electric candle 200 includes at least leaf 110, a flame portion 201, an outer housing 210, an exterior wall 211, a lower region 212, a top edge 214, drippings 215a-n, and an indent central portion 216. In other embodiments, the electric candle 200 may not have all of the elements or features listed and/or may have other elements or features instead of or in addition to those listed.

FIG. 2A shows that electric candle 200 may be formed by installing the inner housing 101 or 102 inside an outer housing that has a look of the exterior of a partially used candle, so that the electric candle 200 looks more realistic.

Flame portion 201 is the entire top portion of the outer housing where the leaf 110 is located. In at least one embodiment, the flame portion 201 is the top part of electric candle 200 that resembles the area of a candle with the wick and flame. In an embodiment, the flame portion 201 includes the leaf 110 and the top part of the outer housing where the leaf 110 sits.

Outer housing 210 is a housing within which the inner housing 101 or 102 sits, so that the inner housing 101 or 102 is hidden from sight. In an embodiment, outer housing 210 has a cylindrical shape that resembles the shape of a cylindrical candle. In other embodiments, outer housing 210 has other shapes that resemble other types of candles. In an embodiment, the exterior wall of the outer housing 210 has a look of a partially used candle. In at least one embodiment, when the inner housing 101 or 102 sits in the outer housing 210, the collar 122 or 191 is inserted through a hole at the top of the outer housing 210, while the leaf 110 sticks out and is visible. In an embodiment, the outer housing 210 is made of paraffin. In another embodiment, the outer housing 210 is made of other materials. In various embodiments, outer housing 210 may include different sizes, shapes, and/or colors.

Exterior wall 211 is the exterior wall of the outer housing 210. In at least one embodiment, the exterior wall 211 includes features such as drippings, streaks, droplets, and/or warps that make the exterior wall 211 looking like a partially used candle. Alternatively or additionally, the exterior wall 211 includes other features and/or structures that make the electric candle 200 realistic.

Lower region 212 is the lowest region of the top edge of the outer housing 210 on one side of the outer housing 210, having a concave shape through which the leaf 110 is visible. In an embodiment, the lower region 212 looks like that a part of the top edge of the partially used candle is burnt away or collapsed a little. In an embodiment, the front side of leaf 110 faces the lower region 212 while the light 160 is behind the leaf 110. Throughout the specification, the side of the leaf 110 facing the lower region 212 is referred to as the front side, while the side of the leaf 110 that is away from the lower region 212 is referred to as the back side.

Top edge 214 is the edge of the outer housing 210 in the flame region 201. In at least one embodiment, the outer housing 210 includes a recessed central portion outlined by the top edge 214, in the middle of which sits the leaf 110. In an embodiment, the top edge 214 has irregular shapes and/or varied height, so as to have an appearance resembling wax on the top edge of the candle that has melted unevenly.

Drippings 215a-n are structures on the exterior wall 211 of the outer housing 210, looking like hot wax drips down the body of a candle and cools to adhere to the body of the candle. In an embodiment, drippings 215a-n and streaks structures extend from the top edge 214 down the exterior wall 211 of the outer housing 210.

Recessed portion 216 is a recessed central area in the flame portion 201 outlined by the top edge 214 in the flame portion 201. In at least one embodiment, the leaf 110 sticks out a hole in the middle at the bottom of the recessed portion 216.

FIG. 2B shows a bottom view 200b of an embodiment of the outer housing 210 of FIG. 2A. Outer housing 210 includes at least exterior wall 211 and indented central portion 216 as discussed in conjunction with FIG. 2A. Outer housing 210 further includes an interior wall 222, an edge 224, and a hole 226. In other embodiments, the outer housing 210 may not have all of the elements or features listed and/or may have other elements or features instead of or in addition to those listed.

FIG. 2B shows a bottom view 200b of the outer housing 210, through which the inner housing 101 or 102 is inserted.

Interior wall 222 is the wall facing inside the outer housing 210. In at least one embodiment, the interior wall 222 includes an edge 224 that is close to the bottom of the outer housing 210. In an embodiment, the edge 224 acts as a stop that prevents the base 150 of inner housing 101 (or base 197 of inner housing 102) to go further into the outer housing 210. In an embodiment, the inner diameter of the bottom of outer housing 210 is equal to or slightly larger than the outer diameter of the base 150 of inner housing 101. In an embodiment, the inner diameter at the bottom of the outer housing 210 is larger than the inner diameter outlined by the interior wall 222.

Hole 226 is a hole or opening in the center of the indented central portion 216, through which the collar 122 or 191 is inserted and the leaf 110 sticks out the hole 226.

FIG. 2C shows a cross sectional side view 200c of an embodiment of the outer housing 210 of FIG. 2A. FIG. 2C includes at least exterior wall 211, indented central portion 216, interior wall 222, edge 224, and hole 226. In other embodiments, FIG. 2C may not have all of the elements or features listed and/or may have other elements or features instead of or in addition to those listed.

FIG. 2C shows a cross sectional view 200c of the outer housing 210 in which the inner housing 101 or 102 sits, with the base 150 or 197 fits at the bottom and below the edge 222 and the collar 122 or 191 inserted in the hole 226. In an embodiment, the friction between the base 150 or 197 and the outer housing 210 holds the inner housing 101 or 102 inside the outer housing 210. Alternatively, tabs or other fasteners may be used to connect the inner housing inside the outer housing 210.

FIG. 3A shows an exploded view 300a of an embodiment of various components inside the inner housing 101. View 300a includes at least leaf 110, hole 112, base portion 114, motor 126, and wire 170, which were discussed in conjunction with FIGS. 1A and 1B. FIG. 3A further includes a focal region 302, a weight 304, a recess area 306, a spring 308, a shaft 310, and electrical wires 322a-b. In other embodiments, the assembly in the view 300a may not have all of the elements or features listed and/or may have other elements or features instead of or in addition to those listed.

FIG. 3A shows a weight attached to the base portion 114 below the wire 170 that goes through the hole 112. The weight has a recess area on one side facing a top portion of a spring. A bottom portion of the spring is attached to a shaft that is connected to the motor 126. In at least one embodiment, the motor 126, when electricity is supplied, rotates the shaft and spring, which cause the leaf 110 to move and vibrate. The vibrating leaf 110 looks like a flickering flame on the wick of the candle, which is lit by the light 160.

Focal region 302 is a region on one side of the leaf 110 facing the light source 160 when the electric candle 100 is assembled. In an embodiment, the focal region 302 is oval shaped and located in the middle along the axis of the leaf 110. In an embodiment, the surfaces of both sides of the leaf 110 are slightly curved while the focal region 302 is flat. When leaf 110 is illuminated, focal region 302 tends to appear brighter than the rest of leaf 110, and has an appearance resembling the core of a flame, having a similar visual appearance to the central region of a flame that is brighter and more concentrated than the rest of the flame. In an embodiment, when not illuminated, the focal region 302 is shallow and difficult to discern with the human eye, but can be seen from an angle when the leaf 110. Focal region 302 is optional.

Weight 304 is a structure that is attached to the base portion 114 of the leaf 110. In at least one embodiment, weight 304 is wider and thicker than the base portion 114. In an embodiment, weight 304 is a rectangular plate having a recess area on one side facing the spring. The recess area is optional. In other embodiments, weight 304 may have other shapes and/or sizes. In at least one embodiment, when the leaf 110 is suspended, at least part of the weight 304 at the bottom is on one side of the spring, below the level of the top of the spring. Weight 304 is at least heavy enough so that when leaf 110 is mounted on wire 170, weight 304 tends to hang downwards and the portion of the leaf 110 that is shaped like a flame tends to stay upward above wire 170. In at least one embodiment, the part of the leaf 110 that is below the hole 112 is heavier than the part of the leaf 110 that is above the hole 112.

Recess area 306 is a recess area on one side of the weight 304, which may be hit and/or rubbed against by the spring when the motor 126 is on. In at least one embodiment, the recess area 306 of weight 304 is a shallow groove that is parallel to the spring and faces the spring, and has a radius that is larger than the radius of the spring. In at least one embodiment, a portion at the bottom of the recess area 306 may be contacted by the spring, causing the weight 304 and leaf 110 to move along the wire 170 (FIG. 1B) and/or rock from side to side.

Spring 308 is a spring with a bottom end attached to a shaft of the motor 126 and a top end free and not attached to anything. In an embodiment, spring 308 is a coil spring. In an embodiment, spring 308 has an inner diameter that is equal to or slightly smaller than the diameter of the shaft, so as to snuggly wraps around the shaft. In an embodiment, the level of the top of the spring 308 is between the top and bottom of the recess area 306 of the weight 304. As the motor 126 rotates the shaft, the spring 308 also rotates about the axis of the spring 308. In an embodiment, as a result of the motor 126 vibrating, the spring 308 vibrates, causing the top of the spring 308 to vibrate slightly and/or swing outwards, slightly. As the top the spring 308 swings outwards and rotates, the spring 308 may hit and/or rub against the recess area 306 of weight 304 and thus causing the leaf 110 to move. In an embodiment, the spring 308 is mounted perfectly straight parallel with the shaft, but nonetheless the vibrations of spring 308 and/or friction between the spring 308 and weight 304, as spring 308 rotates, are enough to cause leaf 110 to move in an erratic motion, so that light shining on the back of the leaf 110 mimics the appearance of a flame. In an alternative embodiment, the spring 308 is not perfectly straight at the top to enhance the vibrations.

Shaft 310 is a shaft or rod that is connected vertically to the motor 126 and spins about the axis of the shaft 310 when the motor 126 is on. In at least one embodiment, the shaft 310 and the spring 308 share the same rotational axis. In at least one embodiment, the top of the shaft 310 is below the bottom of the weight 304. In at least one embodiment, the motor 126 is mounted so that the shaft 310 is perpendicular to the surface on which the electric candle 100a sits. In an alternative embodiment, the shaft 310 is mounted at a slight angle to the surface on which the motor 126 sits, the shaft 310 is slightly crooked, and/or the spring 308 is mounted at a slight angle, to further enhance the vibrations. In at least one embodiment, the assembly of the motor 126, shaft 310, spring 308, wire 170, and weight 304 are hidden from sight.

Electrical wires 322a-b are electrical wires that connect the motor 126 with the circuit 180 and/or conductors in the battery holder 140. In at least one embodiment, the electrical wires 322a-b provide DC current to the motor 126.

FIG. 3B shows an embodiment 300b of an assembly of the various components of FIG. 3A. FIG. 3B shows leaf 110, hole 112, base portion 114, motor 126, wire 170, focal region 302, weight 304, recess area 306, spring 308, shaft 310, and electrical wires 322a-b. In other embodiments, the assembly in the view 300b may not have all of the elements or features listed and/or may have other elements or features instead of or in addition to those listed.

FIG. 3B shows an embodiment of an assembly 300b of the various components of FIG. 3A. The leaf 110 is suspended on the wire 170 with the weight 304 hanging at the same level as the top end of spring 308. The top end of the spring 308 is free and may contact the recess area 306 when the leaf 110 slides on the wire 170 toward the spring 308. When the motor 126 is turned on, the shaft 310 and the spring 308 rotates and vibrates, and the top end of the spring 308 at times rubs against or hits the recess area 306 of the weight 304, causing the leaf 110 to vibrate and/or move erratically.

FIGS. 3C and 3D show an embodiment of the upper portion of leaf 110. The upper portion of leaf 110 includes focal region 302 and walls 324. In other embodiments, the upper portion of leaf 110 may not have all of the elements or features listed and/or may have other elements or features instead of or in addition to those listed.

FIG. 3C shows a cross section 300c of the upper portion of leaf 110, while FIG. 3D shows a back view 300d of the upper portion of leaf 110. FIGS. 3C and 3D portray the shape of the upper portion of leaf 110. As mentioned above, focal region 302 is flat and ovular. Walls 324 have a slight slant (e.g., 0.5 degrees or 1 degree) with respect to the focal region 302.

FIG. 3E shows a cross section 300e of a portion of the electric candle 100. Cross section 300e includes leaf 110, hole 112, collar 122, cover 123, light 160, spring 308, weight 332, lens 334, and wire 370. In other embodiments, view 300e may not have all of the elements or features listed and/or may have other elements or features instead of or in addition to those listed.

Leaf 110, hole 112, collar 122, and cover 123 were discussed above in conjunction with FIG. 1A, for example. Spring 308 was discussed above in conjunction with FIG. 3A. Weight 332 is similar to weight 304, but has a slightly different shape. Nonetheless, weights 332 and 304 function in essentially the same manner. Lens 334 focus the light that is emitted by light 160. Wire 370 is essentially the same as wire 170. In at least one embodiment, to keep the drawings simple, the wire 170 in other figures are not accurately shown as being bent at an angle. Wire 370 is bent upwards at about 5 degrees, so that leaf 110 tends to slide towards spring 308 and stay in contact with spring 308. Wire 370 could be bent at an angel anywhere between 1 degree and 10 degrees or higher, for example. In an alternative embodiment, the angled portion of wire 370 extends up until and/or passed spring 308 to ensure that leaf 110 slides into spring 308 and always comes back in contact with spring 308 after being repelled from spring 308. In an embodiment, the angle of wire 370 is small enough so that leaf 110 slides away from the spring 308 when repelled by spring 308 and temporarily loses contact with spring 308, but the angle is high enough so that eventually leaf 110 slides back towards spring 308.

FIG. 4A shows a cross sectional view 400a of an embodiment of the inner housing 102. FIG. 4A includes at least leaf 110, hole 112, base portion 114, carriage 120, collar 122, motor 126, cover 130, top housing 193, flanges 132a and 132b, battery holder 140, bottom housing 195, base 150, and wire 170, which were discussed in conjunction with FIGS. 1A-1D. FIG. 4A further includes weight 304, recess area 306, spring 308, and shaft 310, which were discussed in conjunction with FIGS. 3A-3B. FIG. 4A also shows batteries 420a-b. In other embodiments, the assembly in the view 400a may not have all of the elements or features listed and/or may have other elements or features instead of or in addition to those listed.

FIG. 4A shows a cross sectional view 400a of the components in an embodiment of the inner housing 102. The top housing 193, bottom housing 195, and base 197 are optional. Two batteries in the battery holder 140 may provide electricity to the circuit 180, motor 126 and light 160.

Batteries 420a-b are electric batteries that may be retained in the battery holder 140 while the electric candle 100a is operatable. In at least one embodiment, batteries 420a-b supply electricity to the circuit 180 that controls the motor 126 and light 160 when the electric candle 100a is turned on. In at least one embodiment, each of batteries 420a-b has a positive terminal and a negative terminal that make electrical connections with complementary connectors in the battery holder 140. In one embodiment, the batteries 420a-b may be standard alkaline batteries or rechargeable batteries. In other embodiments, the electric candle 100a may include other numbers and/or types of batteries. In at least one embodiment, the electric candle 100a may use other power sources, such as a USB charged power source, a power cord, a power source charged by induction charging, any other suitable source, or any combination thereof.

FIGS. 4B and 4C show cross sectional side views 400b and 400c of an embodiment of the inner housing 102, respectively. The cross sectional side views 400b and 400c show at least leaf 110, hole 112, carriage 120, collar 122, covering 123, motor 126, cover 130, top housing 193, battery holder 140, bottom housing 195, base 150, wire 170, weight 304, recess area 306, spring 308, shaft 310, and batteries 420a-b. In other embodiments, the assembly in the views 400b and 400c may not have all of the elements or features listed and/or may have other elements or features instead of or in addition to those listed.

In FIGS. 4B and 4C, the spring 308 is positioned behind the weight 304 with the recess area 306 facing the top end of the spring 308. FIG. 4B shows that the leaf 110 slides backward and toward the covering 123, while the spring 308 hits and/or rubs against the recess area 306 of the weight 304 (and thereby causing the leaf 110 to vibrate or move erratically). FIG. 4C shows that when the leaf 110 slides forward and away from the covering 123, the spring 308 is temporarily not in contact with the weight 304. Occasionally, the leaf 110 may move to a position where the weight 304 is away from the spring 308, while the vibration of the motor 126, friction, and/or a the wind generated by the spinning of spring 308 may cause the leaf 110 to vibrate and move to the position where the weight 304 contacts the spring 308. Alternatively wire 170 may be mounted at an angle so that leaf 110 tends to slide towards spring 308. In another embodiment, the weight 304 is in another position relative to the spring 308 (e.g., behind the spring 308, at either side of spring 308), allowing the spring 308 to contact the recess area 306 when the motor 126 is on. In at least one embodiment, the spring 308 frequently hits the weight 304 as the leaf 110 vibrates and rocks on the wire 170. In an embodiment, the wire 170 is slightly tilted to favor the leaf 110 to be in a position close to the spring 308.

FIG. 5A shows an embodiment 500a of the battery holder 140 of FIG. 1A. FIG. 5A includes at least carriage 120, collar 122, cover 130, flanges 132a and 132b, battery holder 140, base 150, switch 182, and batteries 420a-b. FIG. 5A further includes at least a body 503, tab 505, an opening 506, a slot 507, and holes 509a-b. In other embodiments, the battery holder 140 may not have all of the elements or features listed and/or may have other elements or features instead of or in addition to those listed.

FIG. 5A shows a bottom side view of the battery holder 140, which retains batteries as well as make electrical connections for providing electrical power to the circuit 180, motor 126, and light 160, while the electric candle 100a is operational. FIG. 5A shows a chamber of the battery holder 140 that is uncovered and the batteries are outside of the chamber. In an embodiment, switch 182 is a sliding switch as shown in FIG. 5A, located on one side of an entrance to the chamber. In an embodiment, the base 150 includes a circular ring structure that fits inside the bottom part of the outer housing 210. In an embodiment, batteries are inserted into the battery holder 140 through an opening at the bottom of the base 150. In an embodiment, a door or lid covers the opening at the bottom of the base 150 to retain the batteries. In an embodiment, base 150 may include a switch, optionally at the bottom of the base 150, which controls the on-and-off of the electric candle 100a. In at least one embodiment, the switch, the opening, and the door at the bottom of the base 502 are hidden from sight when the electric candle 100a sits on the base 150. Alternatively or additionally, base 150 may include other structures and/or shapes. The bottom side of the base 150 will be further discussed in conjunction with the description of FIGS. 5A-5E.

Body 503 is a double barrel chamber for holding two batteries. In at least one embodiment, body 503 includes conductors for making electrical connections with the terminals of the batteries. In at least one embodiment, the conductors of battery holder 140 are installed inside the chamber as well as on the door that locks the chamber. In an embodiment, the conductors in the battery holder 140 may include metal tabs, metal coil springs, and/or other structures. In at least one embodiment, body 503 may include electrical wires that connect the conductors to the motor 126, light 160, circuit 180 and/or the switch 182. Additionally or alternatively, body 503 may hold one or more rechargeable batteries (e.g., one or more C type rechargeable batteries, or built-in batteries). In another embodiment, other types of rechargeable batteries may be included such as D type rechargeable batteries. Alternatively or additionally, body 503 may include other structures and/or shapes. In other embodiments, body 503 may hold another number and/or types of batteries (e.g., 1 battery, 3 batteries or 4 batteries).

Tab 505 is a tab at the entrance of the opening between the double barrels for guiding the door into placing the door and supporting the door once the door is locked.

Opening 506 is an opening at the bottom of base 150, through which two batteries may be inserted into the chamber of battery holder 140. In at least one embodiment, opening 506 acts as an entrance to the double barrel chamber of the body 503. In other embodiments, opening 506 may include other shapes and/or sizes.

Slot 507 is a slot or opening at the bottom of the base 150 for engaging a latch of the door so as to lock the door. In an embodiment, slot 507 is on the other side of the opening 506 opposite to the switch 182.

Holes 509a and 509b are two holes or openings for engaging two tabs on the door when the door is locked. In an embodiment, holes 509a and 509b are on the edge of the opening 506 that leads to the chamber.

FIG. 5B shows a bottom view 500b of the battery holder 140 with the batteries 420a-b placed inside the battery holder 140. FIG. 5B shows base 150, batteries 420a-b, switch 182, tab 505, opening 506, slot 507, and holes 509a-b. In other embodiments, the assembly shown in view 500b may not have all of the elements or features listed and/or may have other elements or features instead of or in addition to those listed.

FIG. 5B shows that batteries 420a-b are inserted into the chamber of the body 503. In FIG. 5B, the batteries 420a-b are positioned in a manner that the positive terminal of battery 420b and the negative terminal of battery 420a face outside the opening 506. In an embodiment, the batteries 420a-b are connected in series via conductors inside the chamber of the battery holder 140 and on the door that locks the chamber.

FIGS. 5C and 5D shows different views 500c and 500d of the door 510 having conductors. Door 510 includes at least a latch 512, a tab 514, a spring 516, a conductor 517, a cover 518, and tabs 519a and 519b. In other embodiments, the door 510 may not have all of the elements or features listed and/or may have other elements or features instead of or in addition to those listed.

Door 510 is a door or lid that covers the opening 506 and retains and protects the batteries 420a-b inside the chamber of the battery holder 140. In at least one embodiment, door 510 includes a latch structure on one side of the door 510 for engaging slot 507 and a pair of tabs on the other side of the door 510 for engaging holes 509a and 509b, so as to lock or release the door 510. In at least one embodiment, door 510 includes conductors facing the chamber for making electrical contact with the batteries 420a and 420b when the door 510 is locked. In an embodiment, the conductors on the door 510 include a metal tab and a coil spring that may contact the positive terminal of battery 420b and the negative terminal of battery 420a, respectively. In an embodiment, the metal tab and the coil spring are electrically connected via a conductor.

Latch 512 is a latch structure on one side of the door 510 for engaging with or disengaging from the slot 507 at the bottom of the base 150 to lock or release the door 510. In an embodiment, one end of the latch 512 is connected to the door 510 while the other end biases away from the door 510, so that when the latch 512 is pushed into the slot 507 the latch 512 engages the slot 507 and locks the door 510 to cover the opening 506. Latch 512 is made from a resilient material that tends to keep the shape of the material. In at least one embodiment, the end of latch 512 that is further away from the door 510 may be pressed toward the door 510 to disengage the latch 512 from the slot 507 so that the door 510 may be removed to uncover the opening 506. In at least one embodiment, the latch 512 is made of plastic or other materials. In another embodiment, the latch 512 may be spring loaded, or has other mechanisms for locking and releasing the door 510.

Tab 514 is made of conductive material such as metal for making electrical contact with the positive terminal of battery 420b, when the door 510 is locked. In an embodiment, tab 514 is formed from a convex conductive structure protruding from one end of a piece of conductor for contacting a positive battery terminal. Spring 516 is a metal coil spring attached to the other end of the conductor for making electrical contact with the negative terminal of battery 420a. Conductor 517 electronically connects the tab 514 and spring 516. In an embodiment, conductor 517 is a piece of metal. In an embodiment, tab 514 and spring 516 may be soldered to or otherwise conductively bonded to either end of conductor 517. Alternatively or additionally, the tab 514 and spring 516 may be electrically connected via electrical wires or other structures. In an embodiment, the tab 514 and spring 516 together with the conductor 517 connect the batteries 420a and 420b in series. In other embodiments, the tab 514, spring 516, and conductor 517 may be replaced with other conductors and/or structures that make electrical connections with the terminals of batteries 420a and 420b.

Cover 518 may be a piece of plastic that is attached on one side to the surface of door 510 facing the chamber. In at least one embodiment, cover 518 is parallel to the door 510, forming a slit between the cover 518 and door 150, in which the conductor 517 is fitted while the tab 514 and spring 516 stick out slots on either end of the cover 518.

Tabs 519a-b are two tabs on the other side of the door 510 opposite to the latch 512. In at least one embodiment, tabs 519a-b engage the holes 509a-b for guiding and holding the door 510 in place.

FIG. 5E shows a view 500e of the other side of the door 510. Door 510 may include latch 512, and tabs 519a and 519b. In other embodiments, the door 510 of FIG. 5E may not have all of the elements or features listed and/or may have other elements or features instead of or in addition to those listed.

FIG. 5E shows the other side of the door 510 that faces away from the chamber of the battery holder 140 when the door 510 is locked. Latch 512, tabs 519a, and 519b were discussed above in FIG. 5C. In other embodiments, door 510 may not have all of the elements or features listed and/or may have other elements or features instead of or in addition to those listed.

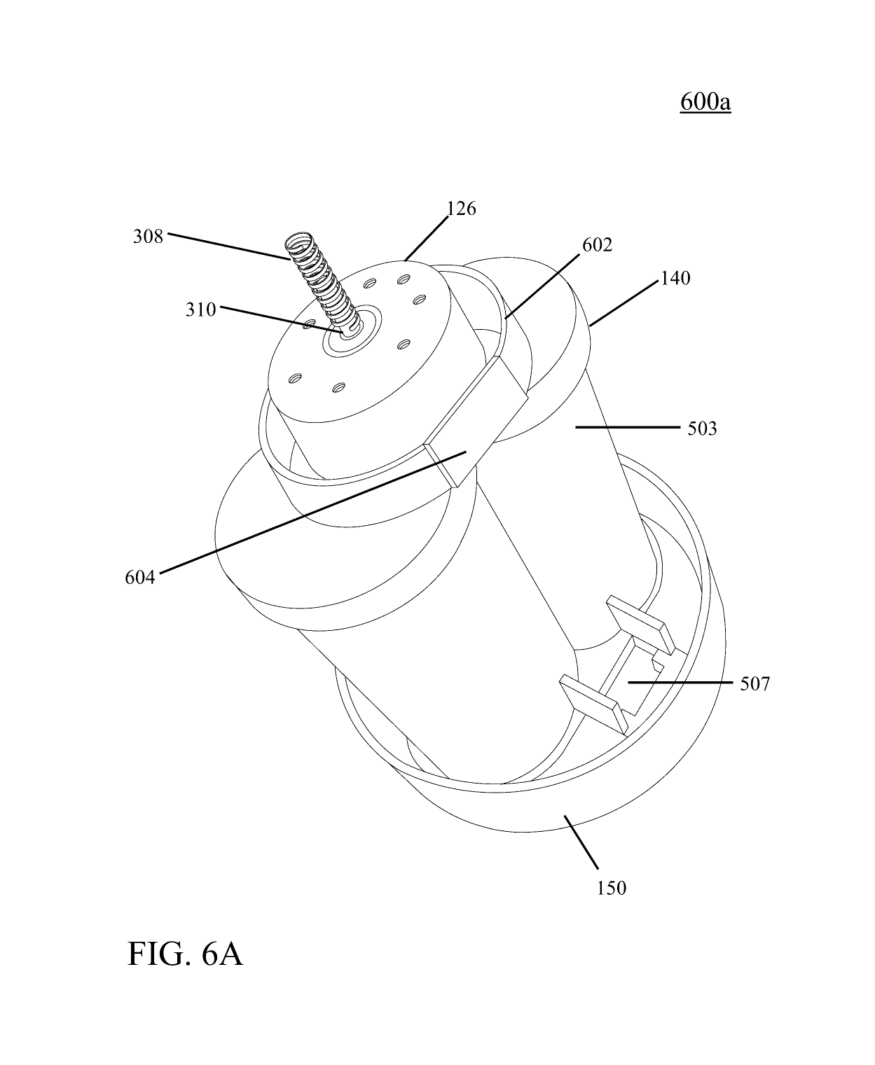

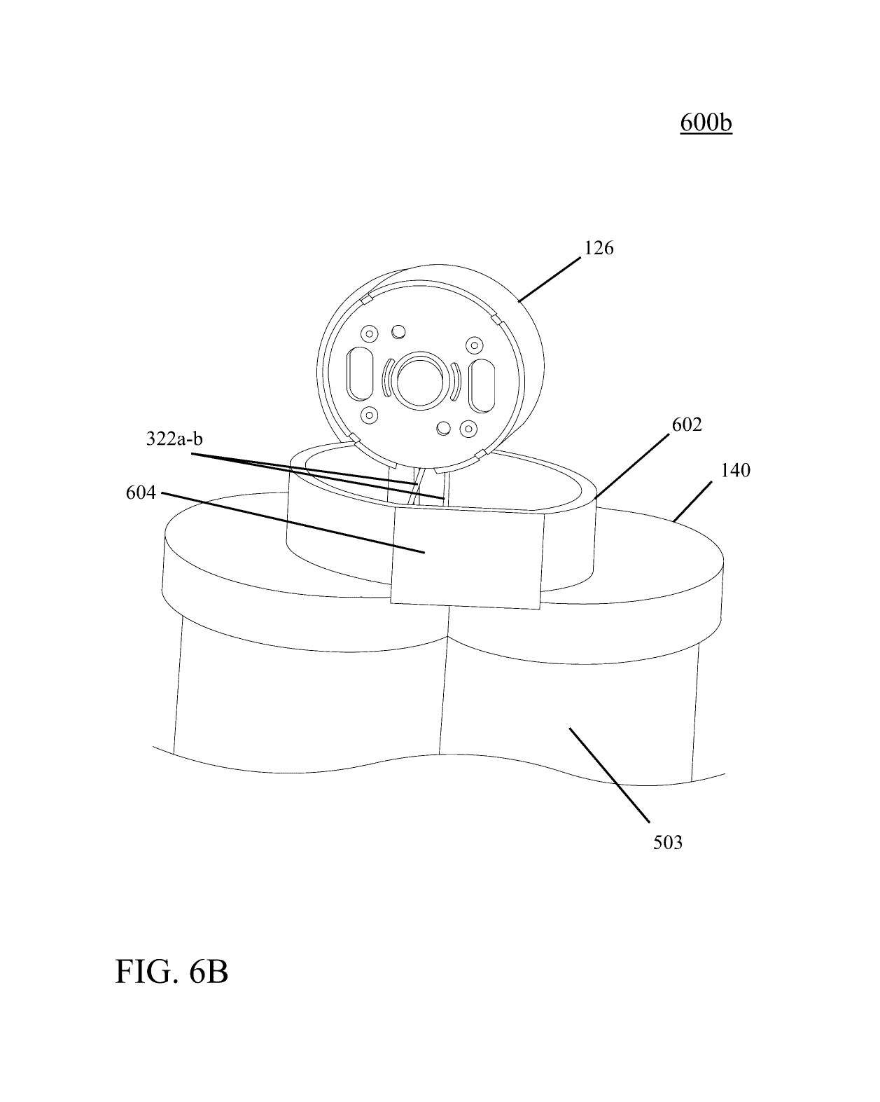

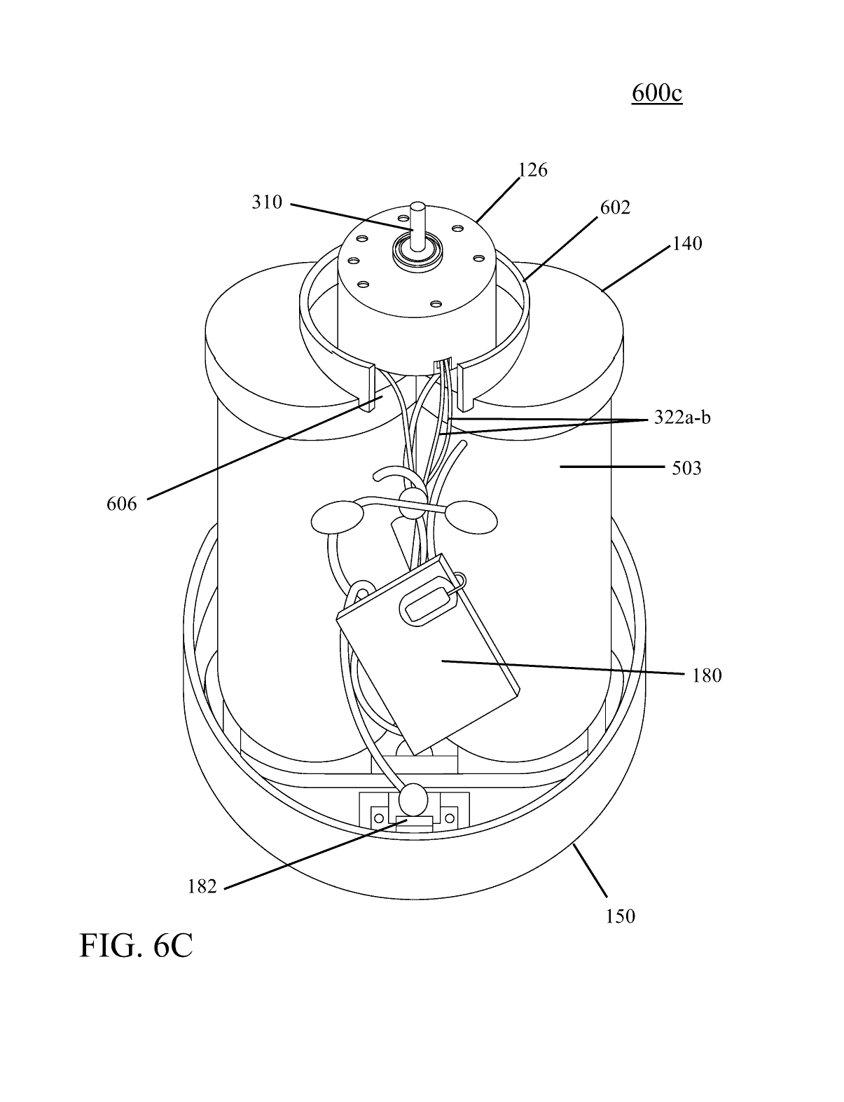

FIG. 6A shows a view 600a of an embodiment of the motor 126 that sits on top of the battery holder 140. FIG. 6A shows the motor 126, battery holder 140, base 150, spring 308, and shaft 310, which were discussed in conjunction with FIGS. 1A, 1B, 3A, and 3B. FIG. 6A also shows body 503 and slot 507, which were discussed in conjunction with FIGS. 5A and 5B. FIG. 6A further shows a top collar 602 and a flat portion 604. In other embodiments, the assembly shown in view 600a may not have all of the elements or features listed and/or may have other elements or features instead of or in addition to those listed.

Top collar 602 is a structure or collar protruding from the top of the battery holder 140, in which the motor 126 sits. In an embodiment, the cover 130 that covers the motor 126 engages the top collar 602. In an embodiment, the top collar 602 includes a hole on one side, facing the side of the switch 182, through which electrical wires go to connect the conductors inside the battery holder 140 to the switch 182 and the circuit 180. The top collar 602 has a flat portion 604 on the other side, opposite to the switch 182. In an embodiment, the flat portion 604 guides the cover 130 to fit on the top collar 602 in alignment.

FIG. 6B shows another view 600b of an embodiment of the motor 126 and the top of the battery holder 140. FIG. 6B shows at least motor 126, battery holder 140, electrical wires 322a-b, body 503, top collar 602, and flat portion 604. In other embodiments, the assembly shown in view 600b may not have all of the elements or features listed and/or may have other elements or features instead of or in addition to those listed.

FIG. 6B shows a closer view 600b of the motor 126 that may be positioned inside the top collar 602 that is on top of the battery holder 140.

FIG. 6C shows another view 600c of an embodiment of the motor 126 that sits on the top of the battery holder 140. FIG. 6C shows at least motor 126, battery holder 140, base 150, circuit 180, switch 182, shaft 310, electrical wires 322a-b, body 503, and top collar 602. FIG. 6C also shows an opening 606. In other embodiments, the assembly shown in view 600c may not have all of the elements or features listed and/or may have other elements or features instead of or in addition to those listed.

FIG. 6C shows a view 600c from another side of the battery holder 140 where the electrical wires 322a-b of the motor 126 and wires from the battery holder 140 are connected to the circuit 180 and switch 182.

Opening 606 is an opening on the side of the top collar 602 facing the circuit 180. In at least one embodiment, electrical wires 322a-b and electrical wires from the battery holder 140 run through the opening 606 to connect to the circuit 180 and switch 182.

FIG. 7A shows a view 700a of an embodiment of the cover 130 of FIG. 1A. Cover 701 may be an embodiment of cover 130. Cover 701 includes two flanges 132a and 132b, which were discussed in conjunction with FIGS. 1A and 1B. FIG. 7A further includes a protrusion 704, a hole 706, a top portion 710, openings 712a and 712b, a bar 714, a base portion 720, and an opening 722. In other embodiments, the cover 701 shown in view 700a may not have all of the elements or features listed and/or may have other elements or features instead of or in addition to those listed.

FIG. 7A shows a view 700a of the cover 701 that covers the motor 126 and engages the top collar 602 of battery holder 140, and connects the carriage 120 to the battery holder 140. The side of cover 701 facing the front side of the electronic candle 100a is referred to as the front side of cover 701, while the side of cover 701 facing the back side of the electronic candle 100a is referred to as the back side of cover 701.

Protrusion 704 is a protrusion or tab on the wall of flange 132a, facing inwards. Alternatively or additionally, a protrusion may be located on the wall of flange 132b facing inwards. In at least one embodiment, protrusion 704 may engage a slot on the side wall of the carriage 120, so as to lock the carriage 120 in-between the flanges 132a and 132b on top of cover 701. In other embodiments, other structures may be used alternatively or in addition to protrusion 704 for engaging complimentary structures on carriage 120 to retain carriage 120 on top of cover 701.

Hole 706 is a hole in the center of a top portion of cover 701, through which the shaft 310 and spring 308 stick out. In an embodiment, hole 706 has a diameter that is larger than the diameter of the shaft 310.

Top portion 710 is the top part of cover 701, under which the motor 126 sits. In at least one embodiment, top portion 710 is a cylindrical cover having an inner diameter that is slightly larger than the diameter of the motor 126.

Openings 712a and 712b are two openings on the sides of the top portion 710 adjacent to the flanges 132a and 132b, respectively. In an embodiment, openings 712a and 712b provide ventilation for the motor 310 that is held under the top portion 710.

Bar 714 is a bar or tab protruding from the top surface of the top portion 710. In an embodiment, bar 714 is perpendicular to the flanges 132a and 132b. In at least one embodiment, the bar 714 meets the bottom edge at the back of the carriage 120 when the carriage 120 sits on top of cover 701.

Base portion 720 is the bottom part of the cover 701, below the top portion 710. In at least one embodiment, base portion 720 has a radius that is greater than the radius of the top portion 710. In an embodiment, flanges 132a and 132b protrude from the top of base portion 720 adjacent to either side of the top portion 710. In an embodiment, base portion 720 is cylindrical and has two flat parts on the front and back side. In an embodiment, the flat part at the back of cover 701 includes an opening.

Opening 722 is an opening in the flat part on the back side of the base portion 720, which when electric candle 100a is assembled is in alignment with the opening 606 in the top collar 602 through which the electrical wires 322a-b and electrical wires from the battery holder 140 are connected to the switch 182 and circuit 180.

FIG. 7B shows another view 700b of an embodiment of the cover 130. Cover 701 includes at least flanges 132a and 132b, protrusion 704, hole 706, top portion 710, opening 712b, bar 714, base portion 720. FIG. 7B shows that the cover 701 includes a flat portion 724 and a tab 726.

Flat portion 724 is on the front side of base portion 720. In at least one embodiment, flat portion 724 meets the flat portion 604 when the cover 701 engages the top collar 602 of the battery holder 140.

Tab 726a is a tab protruding from the bottom inside the cover 701 for holding the motor 126 inside the cover 701. In at least one embodiment, the tab 726 is one of a pair of tabs at the bottom of the cover 701 for holding the motor 126. Although only one tab 726 is shown, in another embodiment, cover 701 may include another number of tabs and/or other structures for holding the motor 126 in place.

FIGS. 8A-D show different views of the leaf 110 that sits in the carriage 120.

FIG. 8A shows a top side view of the carriage 120 and leaf 110. FIG. 8A includes at least leaf 110, hole 112, collar 122, covering 123, opening 124, light 160, and wire 170, which were discussed in conjunction with FIGS. 1A and 1B. FIG. 8A further shows a base 801, a flat wall 802a, an indent 803, electrical wires 804a-b, flat portion 805, and curved portion 807. In other embodiments, the assembly shown in view 800a may not have all of the elements or features listed and/or may have other elements or features instead of or in addition to those listed.

FIG. 8A shows that leaf 110 is suspended on the wire 170 and the back side of the leaf 110 is illuminated by the light 160 that is installed on the covering 123 behind the leaf 110.

Base 801 is the base part of the carriage 120 from which the collar 122 protrudes upwards. In an embodiment, base 801 fits in-between the flanges 132a-b of the cover 130. In at least one embodiment, the collar 122 is located close to the back side of the base 801. In an embodiment, base 801 includes two flat walls on either side, and an indent at the back side facing the bottom of the base 801.

Flat wall 802 is a flat part of the side wall of the base 801. In at least one embodiment, the base 801 includes two flat walls on either side that may be inserted between flanges 132a-b.

Indent 803 is an indent at the back of the base 801 facing the bottom of base 801. In at least one embodiment, indent 803 is outlined by a flat portion of the wall at the back of the carriage 120. In an embodiment, the leads or electrical wires of the light 160 that is installed on the covering 123 extend through the indent 803 to further connect to the circuit 180. In an embodiment, indent 803 helps to identify the front side and back side of carriage 120 during assembly of the electric candle 100a.

Electrical wires 804a-b electrically connects the light 160 with the circuit 180. In an embodiment, the leads of the light 160 protrude from the indent 803 and the electrical wires 804a-b are soldered to the leads. In another embodiment, electrical wires 804a-b go through the wall at the indent 803 to connect to the light 160 installed on the covering 123.

Flat portion 805 is a flat wall at the back of the base 801, outlining the indent 803. In an embodiment, the bottom edge of flat portion 805 meets the bar 714 on top of the covering 130 when the carriage 120 sits on top of covering 130.

Curved portion 807 is a curved portion of the wire 170, which is above the light 160 and curved to one side of the light 160. In an embodiment, curved portion 807 of the wire 170 allows the light to directly shine on the leaf 110 with minimal blockage by the wire 170.

FIG. 8B shows a front view 800b of an embodiment of the carriage 120 and the front side of the leaf 110. FIG. 8B includes at least leaf 110, hole 112, collar 122, covering 123, opening 124, base 801, flat wall 802a, and a flat wall 802b. In other embodiments, the assembly shown in view 800b may not have all of the elements or features listed and/or may have other elements or features instead of or in addition to those listed.

FIG. 8B shows another view 800b of the leaf 110 sitting in the carriage 120. Flat wall 802b is on the other side of the base 801 opposite to the flat wall 802a.

FIG. 8C shows a view 800c from the bottom of the carriage 120. FIG. 8C includes leaf 110, hole 112, base portion 114, covering 123, opening 124, wire 170, weight 304, recess area 306, base 801, flat wall 802a, indent 803, electrical wires 804a-b, and flat portion 805. FIG. 8C further shows a flat wall 802b and a slot 809. In other embodiments, the assembly shown in view 800c may not have all of the elements or features listed and/or may have other elements or features instead of or in addition to those listed.

FIG. 8C shows a view 800c from the bottom of the carriage 120, in which the weight 304 is attached to the base portion 114 of the leaf 110 that sits in the opening 124, while the base portion 114 is mounted on the wire 170. FIG. 8C further shows a flat wall having a slot on the other side of the base 801, opposite to the flat wall 802a. In FIG. 8C, electrical wires 804a-b is connected to the light 160 through the wall at the indent 803.

Slot 809 is a slot on the flat wall 802b for engaging the tab 704 on the flange 132b so as to retain the carriage 120 on top of the cover 130. Alternatively or additionally, the carriage 120 may include other structures, such as tabs, notches, and/or protrusions, which engage complementary structures on the cover 130.

FIG. 8D shows a top view 800d of the leaf 110 and carriage 120. FIG. 8D shows leaf 110, collar 122, covering 123, opening 124, light 160, wire 170, weight 304, recess area 306, base 801, flat walls 802a and 802b, and curved portion 807. In other embodiments, the assembly shown in view 800d may not have all of the elements or features listed and/or may have other elements or features instead of or in addition to those listed.

FIG. 8D shows a view of the leaf 110 that is suspended on the wire 170 while the leaf 110 may move in the opening 124. The recess area 306 of the weight 304 faces backward and may contact the spring 308 when the motor 126 is on. The light 160 on the covering 123 shines on the back side of the leaf 110, while the wire 170 includes a curved portion 807 so as not to block the light. In an embodiment, the axle of the collar 122 is different from the axle of the base 801 of the carriage 120.

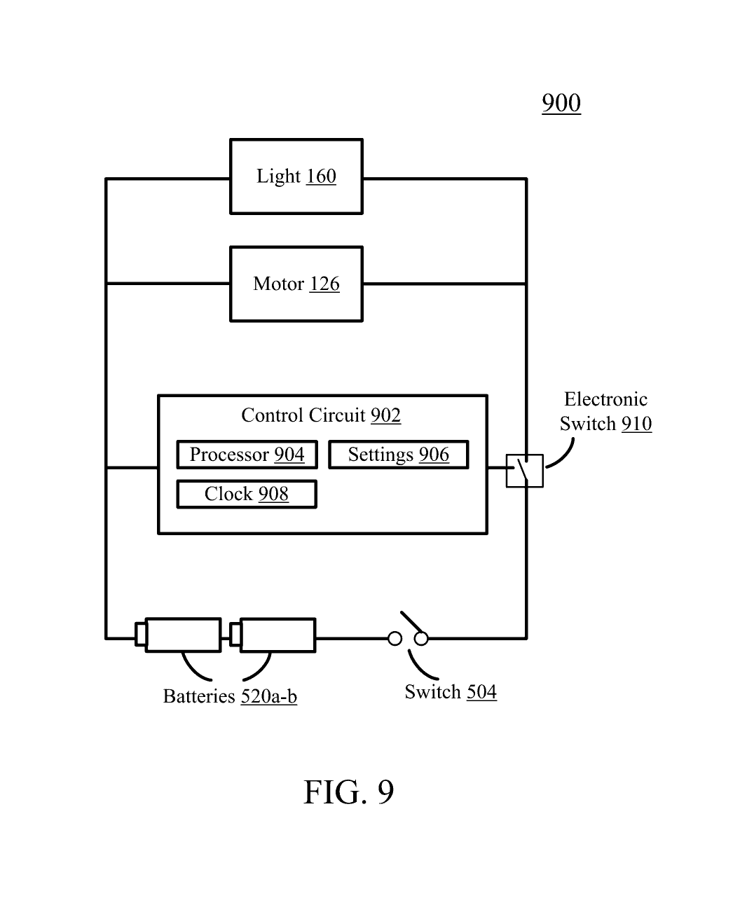

FIG. 9 shows a diagram 900 of an embodiment of the circuit 180 that controls the on-and-off of light 160 and motor 126. FIG. 9 includes at least light 160, motor 126, switch 182, and batteries 420a-b. FIG. 9 further includes a control circuit 902, a processor 904, a memory 905, settings 906, a clock 908, and an electronic switch 910. In other embodiments, the circuit in FIG. 9 may not have all of the elements or features listed and/or may have other elements or features instead of or in addition to those listed.

FIG. 9 shows that a control circuit controls an electronic switch that could turn on and cut off the electricity supplied from the batteries 420a-b to the light 160 and motor 126 of electronic candle 100 based on various settings.

Control circuit 902 is an electronic circuit that includes individual electronic components (e.g., resistors, transistors, capacitors, inductors and diodes) that are connected by conductive wires or traces through which electric current can flow. In at least one embodiment, control circuit 902 includes a circuit board on which the electronic components are soldered or otherwise attached. In at least one embodiment, the combination of components and wires of control circuit 902 allows various operations to be performed, such as turning on and off an electrical switch at certain time and/or for certain period of time based on different settings. In other embodiments, control circuit 902 may include other components and/or structures for controlling the performance of electric candle 100a.

Processor 904 may include any one of, some of, any combination of, or all of multiple parallel processors, a single processor, a system of processors having one or more central processors and/or one or more specialized processors dedicated to specific tasks. In at least one embodiment, processor 904 may implement instructions to control the electronic switch based on the settings.

Memory 905 is a memory system for storing instructions and/or settings that may be implemented by the processor 904. Memory 905 may include, for example, any one of, some of, any combination of, or all of a long term storage system, such as a hard drive; a short term storage system, such as random access memory; a removable storage system, such as a floppy drive or a removable drive; and/or flash memory. Memory system 905 may include cache memory accessible by the processor 904.

Settings 906 include various settings and/or parameters that may be input and/or chosen by the user (or preset prior to giving electric candle 100a to the user) for controlling switching the transmission of electricity to the light 160 and motor 126. In at least one embodiment, the user and/or manufacturer may input one or more settings 906 into the control circuit 902, such as time periods (e.g., 30 minutes, one hour, two hours, etc.) to keep the electric candle 100a on before the control circuit 902 automatically shuts off the electrical switch. Optionally, the user may be able to directly input or choose from settings 906 the time to turn on the electric candle 100a and/or the time period to keep the electric candle 100a on before the electric candle 100a is automatically shut off. In an embodiment, the electric candle 100a may include input buttons and/or screens for the user to input and/or select from the settings 906. Alternatively or additionally, electric candle 100a may include one or more control switches for inputting and/or adjusting the settings 906. Alternatively or additionally, the electric candle 100a may include wireless transceivers to receive control commands from remote controllers and/or mobile devices to adjust the settings 906 and/or directly turn on and off the electric candle 100a. In other embodiments, settings 906 may include other settings and/or modes. In an embodiment, settings 901 and/or instructions for implementing the settings 906 may be stored in the memory 905 in the control circuit 902.

Clock 908 is a circuit that produces a timing signal that may be used by the processor 904 to determine, in combination with settings 906, the time to turn on and off the electrical switch and thus to turn on and off the light 160 and motor 126. Clock 908 is optional. The processor 904 may include its own internal clock which may be used for keeping track of the time and when to implement various instructions, such as the turning on or turning off of the light 160 and/or motor 126.

Electronic switch 910 is an electronic component or device that can open or close an electrical circuit, and/or divert electric current from one conductor to another, such as a transistor, relay, avalanche diode, or other threshold device. In at least one embodiment, control circuit 902 controls the electronic switch 910 to turn on and cut off the transmission of electricity to the light 160 and motor 126.

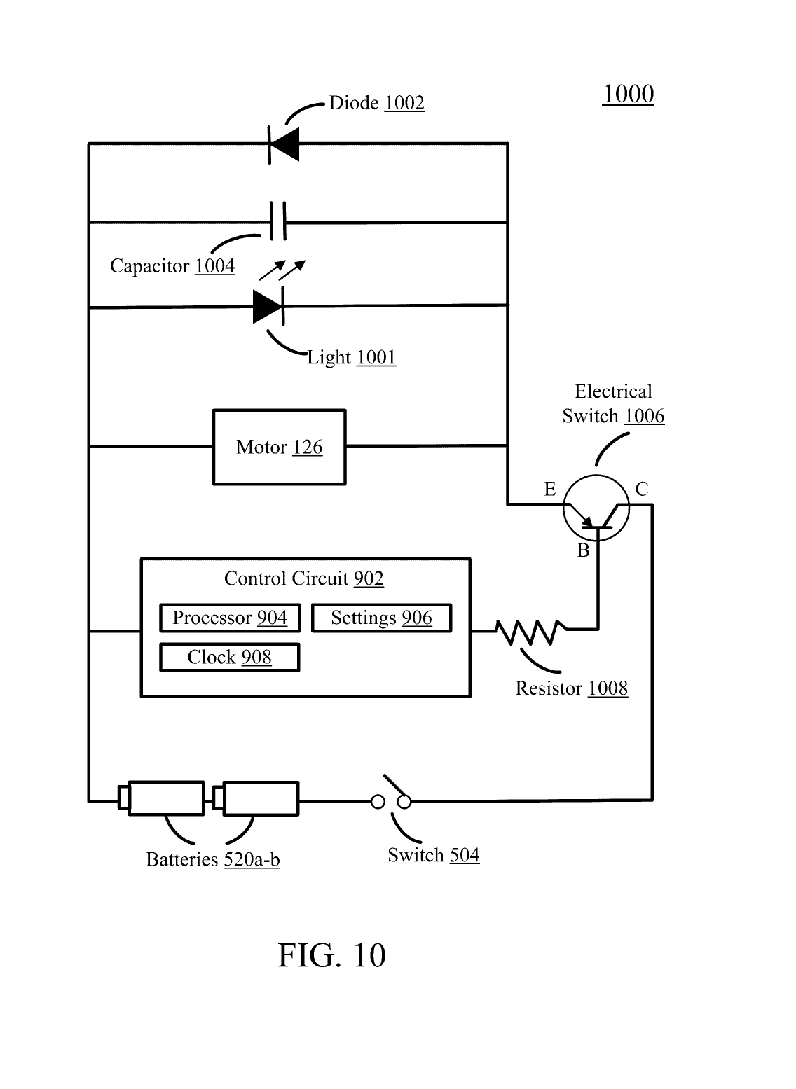

FIG. 10 shows a diagram 1000 of another embodiment of the circuit 180 of FIG. 9. FIG. 10 includes at least motor 126, switch 182, batteries 420a-b, control circuit 902, processor 904, settings 906, and clock 908. FIG. 10 further includes a light 1001, a diode 1002, a capacitor 1004, an electrical switch 1006, and a resistor 1008. In other embodiments, the circuit in diagram 1000 may not have all of the elements or features listed and/or may have other elements or features instead of or in addition to those listed.

FIG. 10 shows that the control circuit 902 controls a transistor to turn on and off an LED light and motor 126 of electronic candle 100. FIG. 10 shows the light, motor 126, a diode, and a capacitor are connected in parallel.

Light 1001 may be a light-emitting diode (LED). In an embodiment, light 1001 is an embodiment of the light 160. In an embodiment, light 1001 emits light that has a yellowish color. In an embodiment, light 1001 and motor 126 are connected in parallel. Alternatively or additionally, electric candle 100a may include other types of light sources.

Diode 1002 is a two-terminal electronic component with asymmetric conductance. Diode 1002 has low resistance to current in one direction, and high resistance in the other, so as to cause the current to flow in the direction that has a low resistance. In at least one embodiment, diode 1002 is connected to the light 1001 and motor 126 in parallel. In an embodiment, diode 1002 acts to smooth out the noise of the current that may be generated by the motor 126, batteries 420a-b, and/or other components in FIG. 10. Diode 1002 is optional.

In an embodiment, capacitor 1004 is a passive two-terminal electrical component used to store energy electrostatically in an electric field. In an embodiment, capacitor 1004 includes at least two electrical conductors (e.g., plates) separated by a dielectric (e.g., insulator). In at least one embodiment, capacitor 1004 is connected to the light 1001 and motor 126 in parallel. In an embodiment, capacitor 1004 acts to stabilize power flow and smooth the noise of the current that may be generated by the motor 126, batteries 420a-b, and/or other components in FIG. 10. Capacitor 1004 is optional.

Electrical switch 1006 may be a semiconductor device that is used as an electrical switch in FIG. 10, such as a transistor, to control the electricity supplied to the light 1001, motor 126, and/or other electrical components. In at least one embodiment, the control circuit 902 controls the electrical switch 1006 to turn on and off the light 1001 and motor 126. In at least one embodiment, the electrical switch 1006 includes semiconductor material with at least three terminals for connection to an external circuit. In an embodiment, electrical switch 1006 is a bipolar transistor. For example, a PNP transistor is shown in FIG. 10, with the base (B) of the transistor connected to the control circuit 902 that controls the current flow between the emitter (E) and the collector (C). In an embodiment in which electrical switch 1006 is a transistor, when the current supplied to the base crosses a threshold, the electrical switch 1006 is turned on, and the current between the emitter and collector rise exponentially. As a result, electricity is transmitted to the light 1001 and motor 126 in FIG. 10. Alternatively, the electrical switch 1006 may be an NPN transistor or other types of transistors that is controlled by the control circuit 902 to turn on and off the light 1001 and motor 126. Alternatively or additionally, a relay or other types of electrical switches may be used to control the electric candle 100a.

Resistor 1008 is a passive two-terminal electrical component that implements electrical resistance as a circuit element. In at least one embodiment, resistor 1008 is connected to control circuit 902 in series, acting to reduce the voltage and current flow of the control circuit 902.

### Method of Using

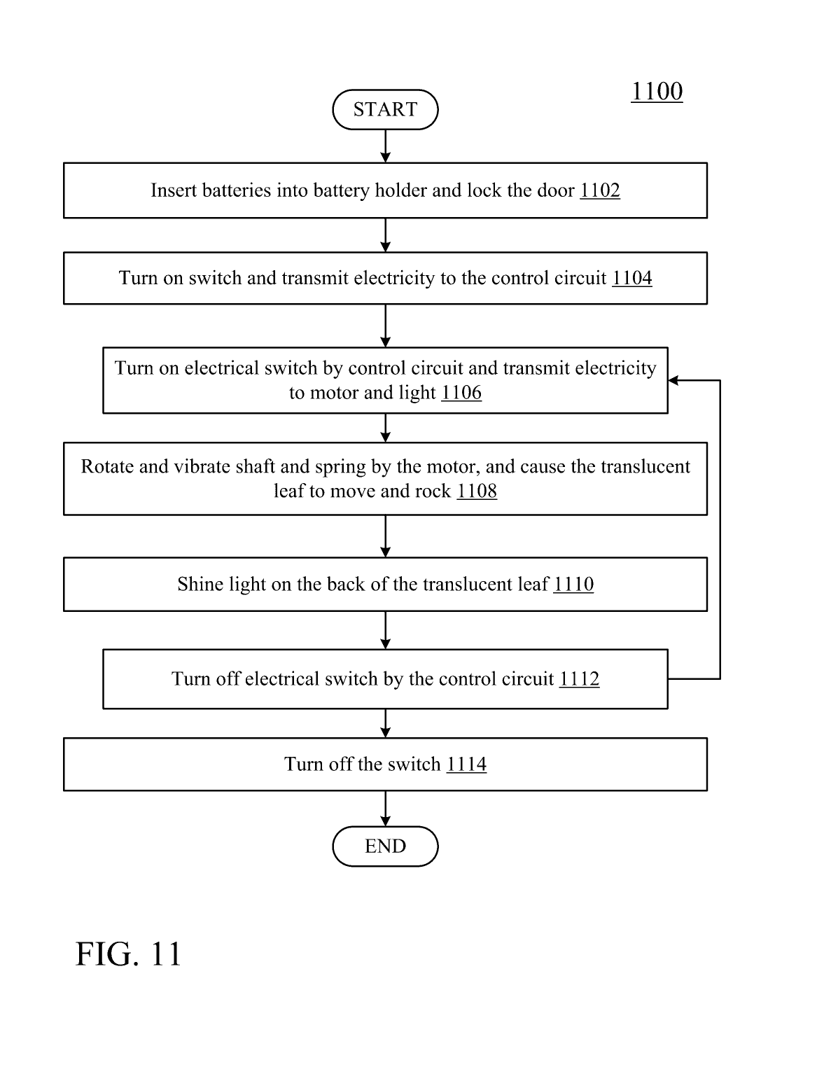

FIG. 11 is a flowchart of an embodiment of a method 1100 of using the electric candle 100a.

In step 1102, batteries 420a-b are inserted into the battery holder 140 in the manner as discussed in FIGS. 5A and 5B. As part of the step 1102, door 510 is locked to retain the batteries 420a-b in the battery holder 140.

In step 1104, turn on the switch 182 on the bottom of the battery holder 140. Electricity is transmitted from the batteries 420a-b to the control circuit 902 that controls the on and off of the motor 126 and the light 160 based on the settings 906.

Steps 1102 and 1104 are optional in the sense that if the batteries 420a-b are already in the electric candle 100a and the door 510 is already shut, step 1102 and 1104 do not need to be performed.

In step 1106, the control circuit 902 activates the electrical switch 910 to provide electricity to the motor 126 and light 160 according to the settings 906. In an embodiment, the control circuit 902 turns on the electrical switch 910 at pre-set time and/or keep the motor 126 and light 160 on for a predetermined time period.

In step 1108, the motor 126 rotates and, as a result, the shaft 310 and spring 308 rotate and vibrate. As part of step 1108, the top of the spring 308, when rotating and optionally swinging slightly outwards, hits or rubs against the recess area 306 of the weight 304 that is attached to the base portion 114 of the leaf 110, causing the leaf 110 to move back and forth on the wire 170 and to rock from side to side and back and forth in an erratic motion, without any noticeable pattern.

In step 1110, light 160 shines on the back of the leaf 110. In an embodiment, steps 1108 and 1110 take place simultaneously. As the leaf 110 rocks and slides back and forth, the light shining through the leaf 110 appears like a flame.

In step 1112, the control circuit 902 turns off the electrical switch 910 based on the settings 906, and thereby cuts off the electricity to the motor 126 and light 160. In at least one embodiment, in a period of time after step 1112, the control circuit 902 turns the electrical switch 910 back on based on the settings 906 (and steps 1106-1112 are repeated), so that the electric candle 100a is turned back on for another period of time.

In step 1114, the switch 182 is turned off. In an embodiment, the switch 182 is intentionally shut off by a user.

In an embodiment, each of the steps of method 1100 is a distinct step. In another embodiment, although depicted as distinct steps in FIG. 11, step 1102-1114 may not be distinct steps. In other embodiments, method 1100 may not have all of the above steps and/or may have other steps in addition to or instead of those listed above. The steps of method 1100 may be performed in another order.

### Method of Assembling

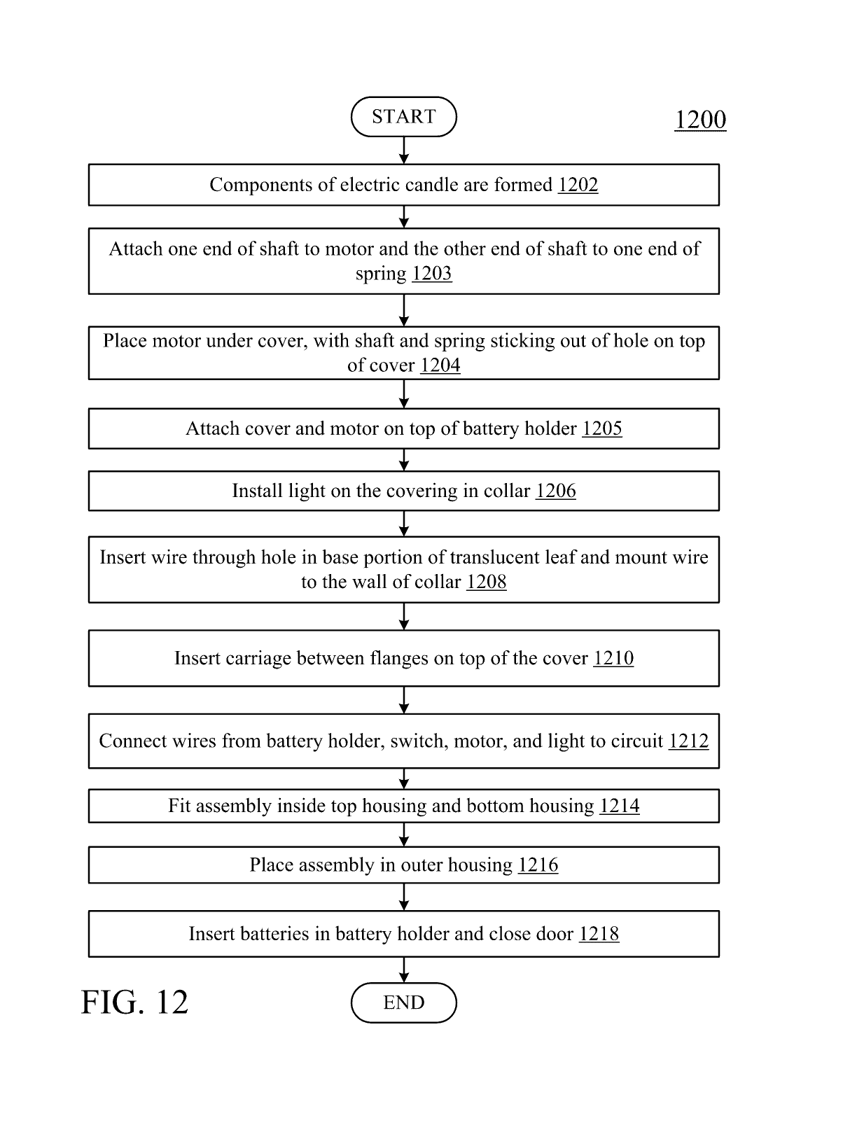

FIG. 12 is a flowchart of an embodiment of a method 1200 of assembling the electric candle 100a.

In step 1202, the leaf 110 with the weight 304 is formed. Alternatively, the weight 304 is attached to the base portion 114 of the leaf 110. As part of step 1202, the light 160, wire 170, motor 126, spring 308, and shaft 310 are formed. As part of step 1202, the inner housing 101, outer housing 210, carriage 120, cover 130, battery holder 140, door 510, and circuit 180 are also formed.

In step 1203, one end of shaft 310 is attached to the motor 126, while the other end of the shaft 310 is attached to one end of the spring 308. In an embodiment, the other end of spring 308 is free and not attached to anything.

In step 1204, the motor 126 is placed under the cover 130, with the shaft 310 and the spring 308 sticking out through the hole 706 on the top of the cover 130.

In step 1205, the cover 130 is attached on the top of the battery holder 140, thereby retaining the motor 126 between the cover and the top collar 602 of the battery holder 140.

In step 1206, light 160 is installed on the covering 123 inside the collar 122.

In step 1208, wire 170 is inserted through hole 112 in the base portion 114 of the leaf 110, so that wire 170 is perpendicular to the surface of the leaf 110. As part of step 1208, the wire 170 is mounted to the wall of the collar 122 above the opening 124, thereby suspending the leaf 110 in the carriage 120. In an embodiment, the curved portion 807 of the wire 170 is positioned above and in adjacent to the light 160.

In step 1210, the carriage 120 is inserted between two flanges 132a and 132b on the top of the cover 130, so that the weight 304 is on one side of the top end of the spring 308.

In step 1212, electrical wires 322a-b of the motor 126 and electrical wires 804a-b of the light 160 are connected to the circuit 180. As part of step 1212, circuit 180 is also connected to the conductors in the battery holder 140 and switch 182 via electrical wires.

In step 1214, the assembly is fitted in the top housing 193 and bottom housing 195. Step 1214 may be optional.

In step 1216, the assembly is placed in the outer housing 210, with the front side of leaf 110 facing the concave 212 and the light 160 away from the concave 212. In an embodiment, the assembly covered by the top housing 193 and bottom housing 195 may be placed inside the outer housing 210.

In step 1218, the door 510 is locked to cover the chamber of the battery holder 140. Optionally as part of step 1218, the batteries 420a-b are inserted into the chamber of the battery holder 140 before the door 510 is locked. Alternatively, batteries 420a-b may not be installed during manufacture and/or for sale, and a user may insert the batteries 420a-b before start using the electric candle 100a.

In an embodiment, each of the steps of method 1200 is a distinct step. In another embodiment, although depicted as distinct steps in FIG. 12, step 1202-1218 may not be distinct steps. In other embodiments, method 1200 may not have all of the above steps and/or may have other steps in addition to or instead of those listed above. The steps of method 1200 may be performed in another order.

### Alternatives and Extensions

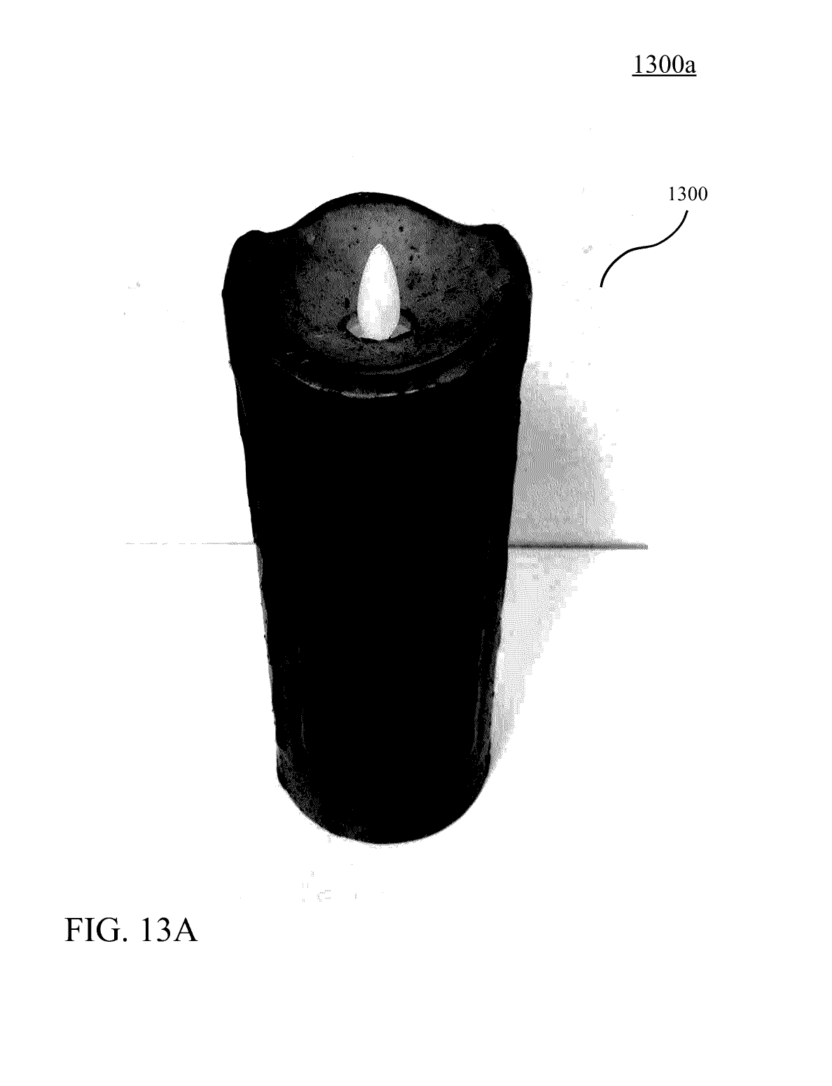

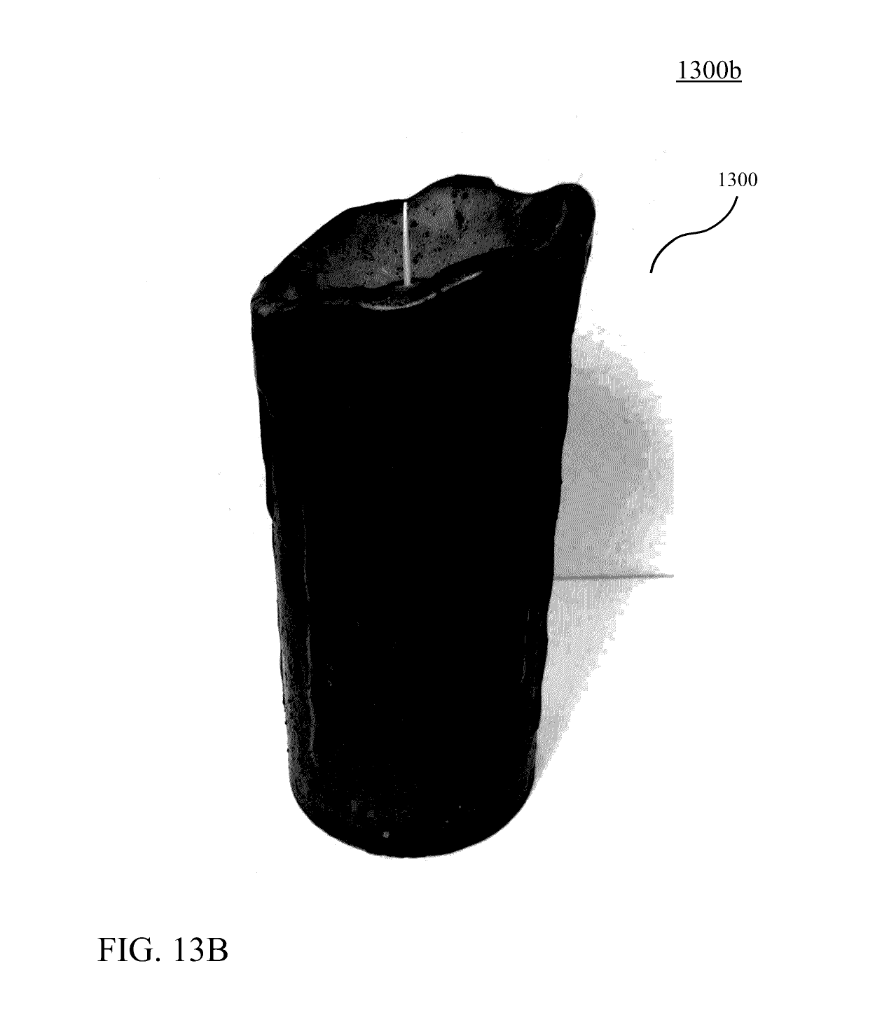

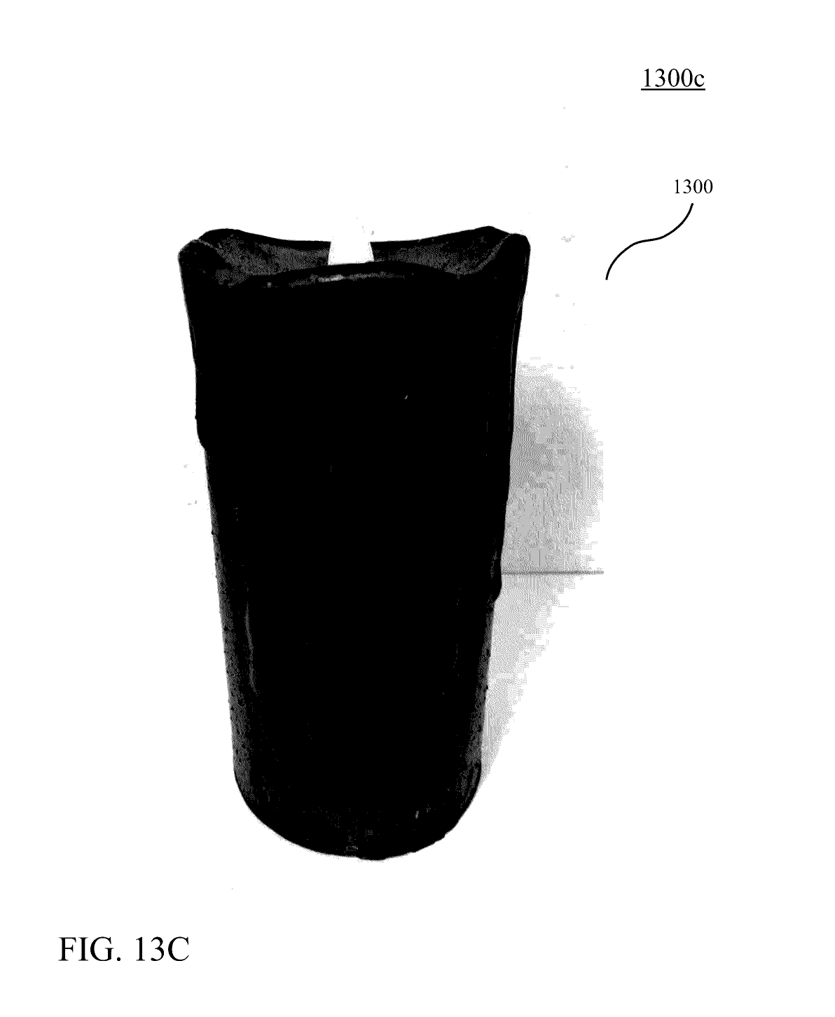

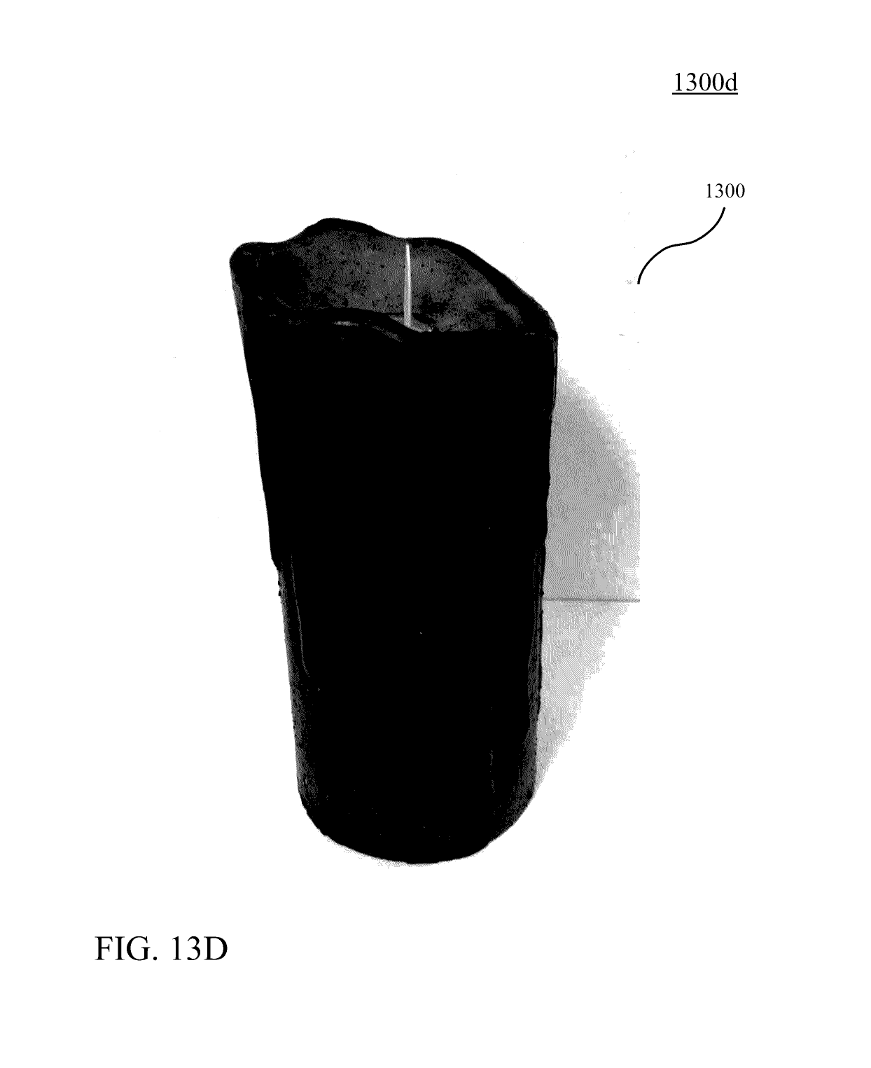

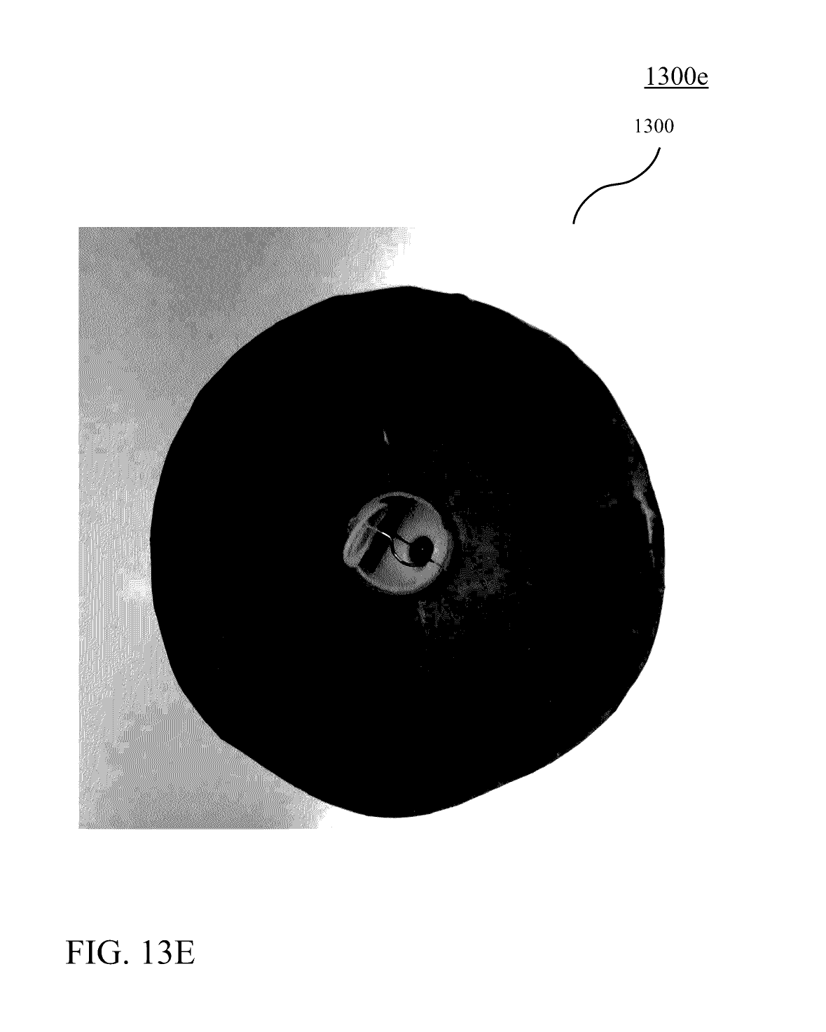

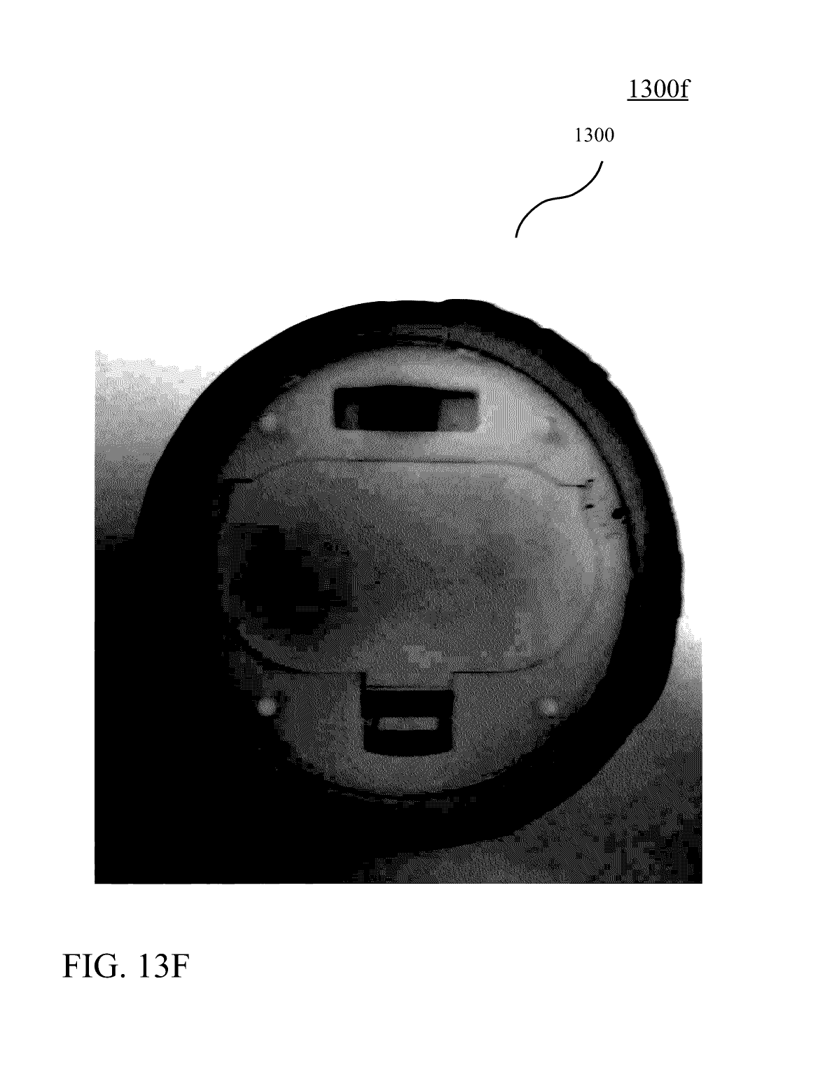

FIGS. 13A-F show different views of an embodiment of electric candle 100a. FIGS. 13A-F show photos that include a front view (1300a), a side view (1300b), a back view (1300c), another side view (1300d), a top view (1300e), and a bottom view (1300f) of electric candle 1300, respectively.

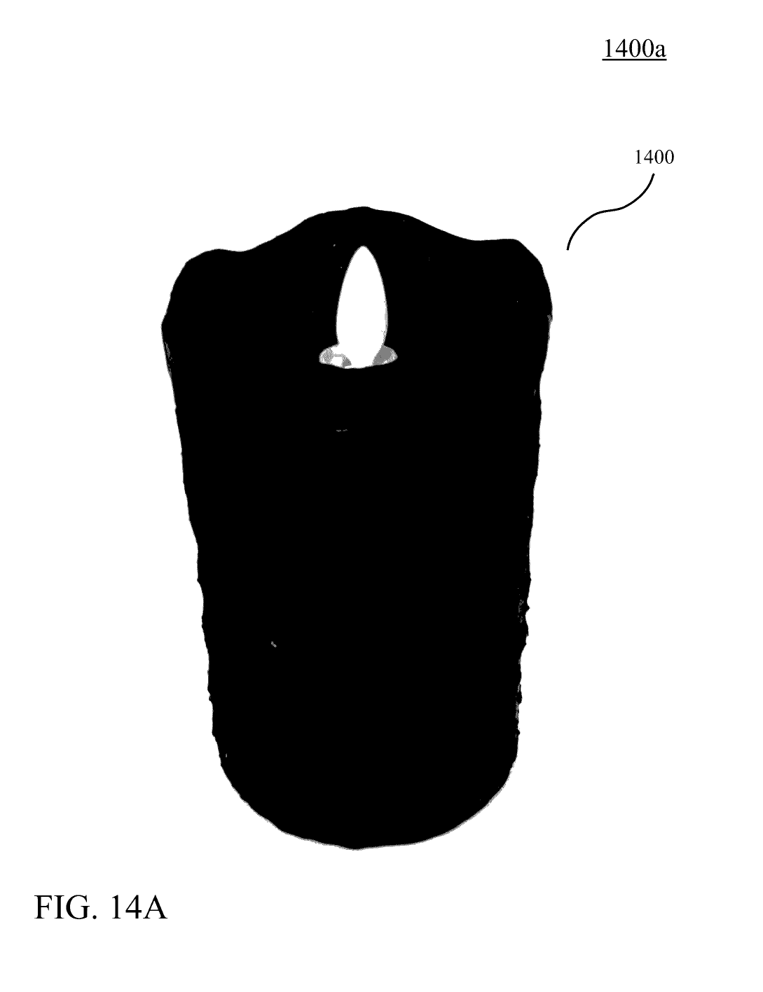

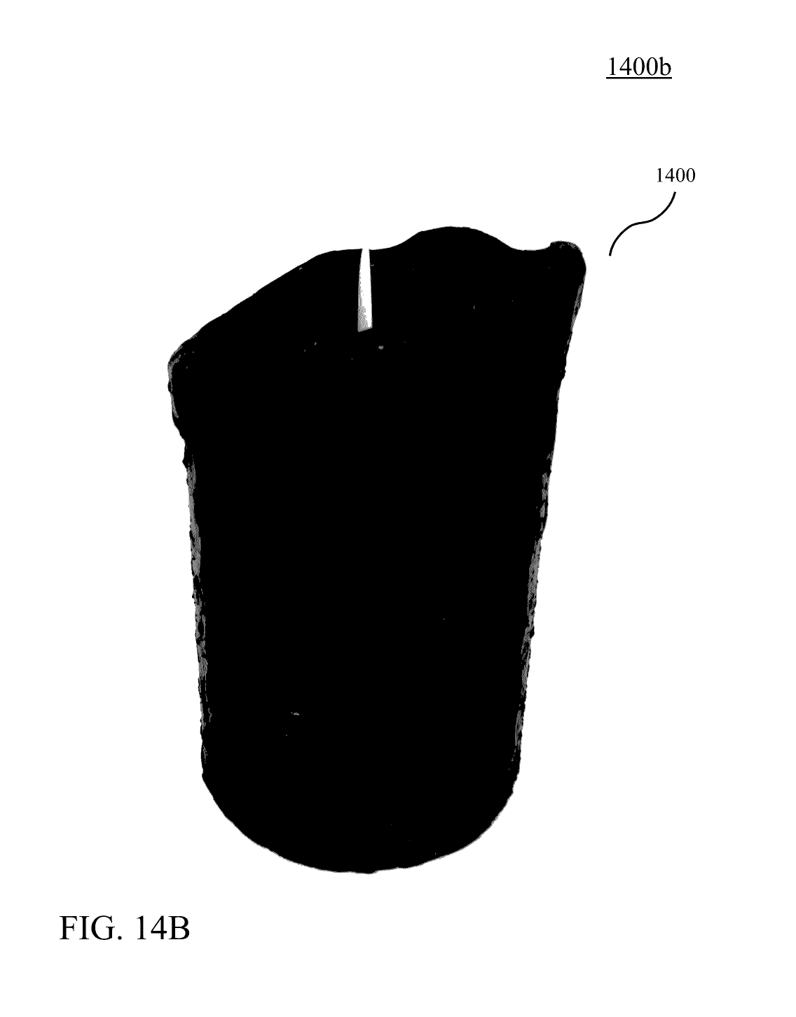

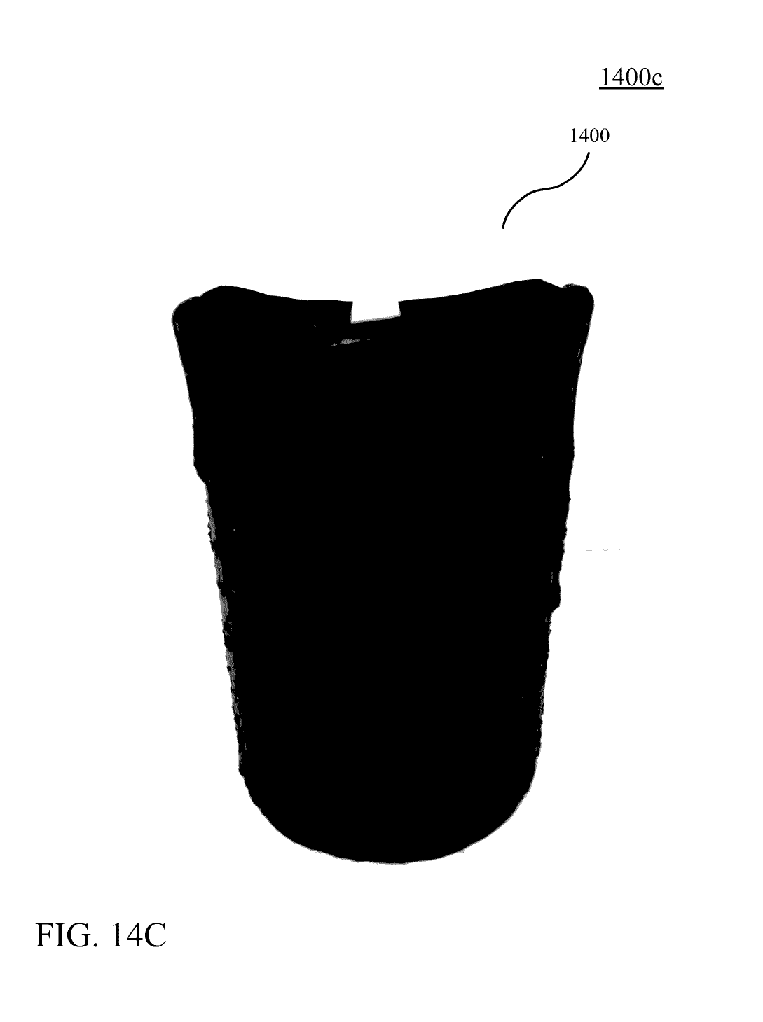

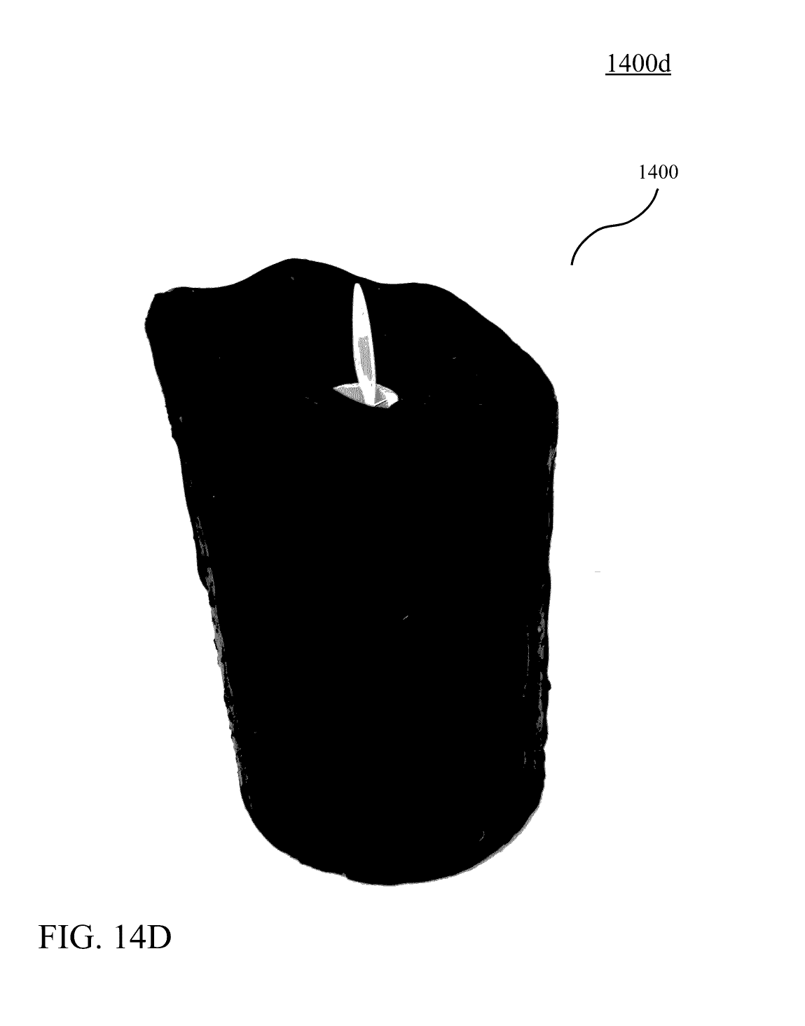

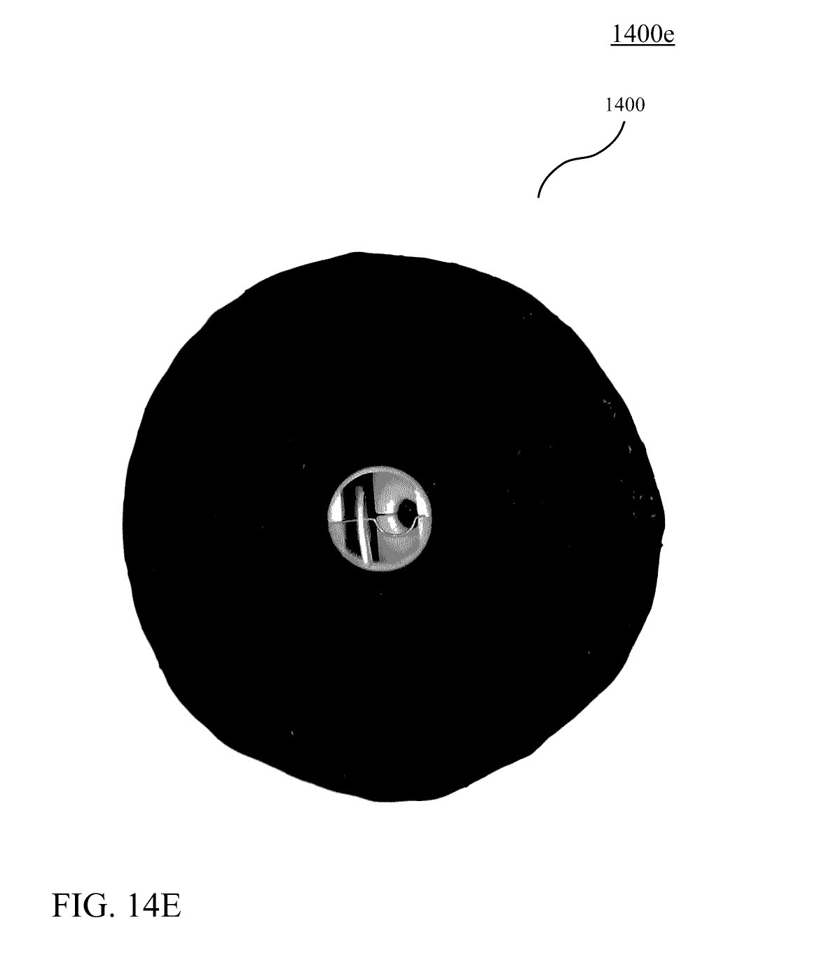

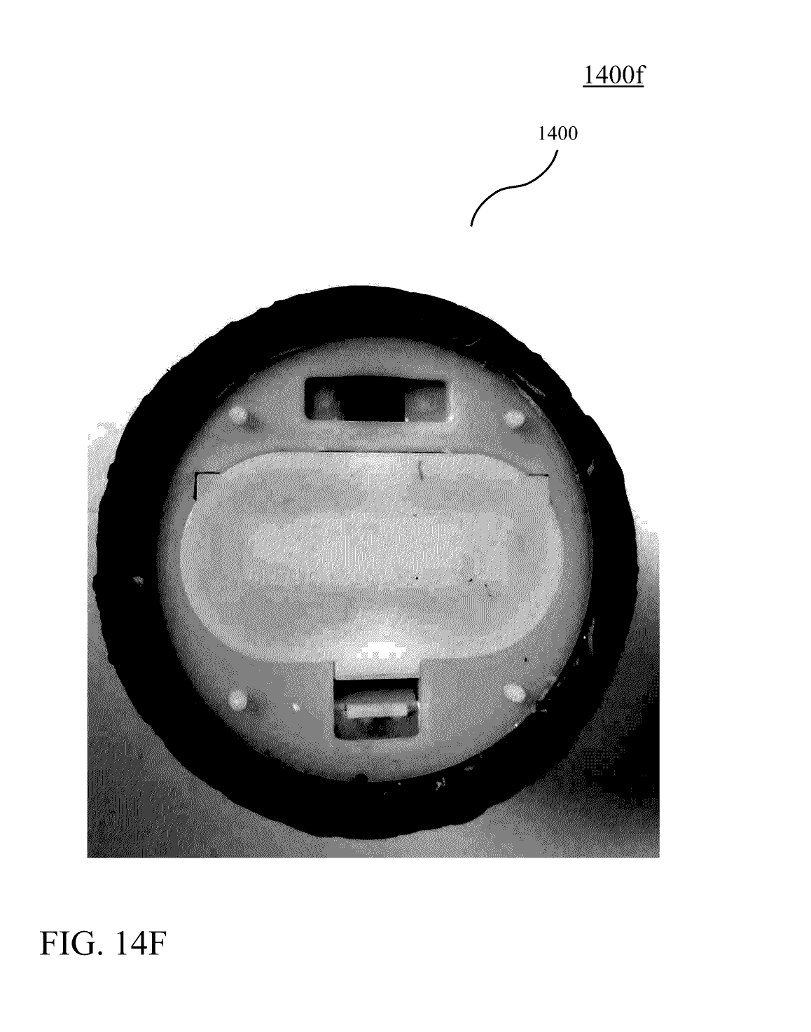

FIGS. 14A-F show different views of another embodiment of the electric candle 100a. FIGS. 14A-F show photos that include a front view (1400a), a side view (1400b), a back view (1400c), another side view (1400d), a top view (1400e), and a bottom view (1400f) of electric candle 1400, respectively. In at least one embodiment, the electric candle 1300 in FIGS. 13A-F and electric candle 1400 in FIGS. 14A-F have different sizes and/or shapes.

Optionally, front lighting may be included in addition to, and/or instead of back lighting. If front lighting is used, the leaf 110 may be replaced with a reflective leaf, and the front of the leaf 110 may have a rough surface or other light diffusing surface. In an embodiment, light source may be located in front of the reflective leaf that reflects the light emitted by the light source. Optionally, a plurality of leaves may be used, and one or more of the plurality of leaves may be reflective and one or more of the plurality of leaves may be translucent. Optionally, instead of relying on vibrations of the motor 126 that were not intended by the manufacturer, the motor 126 may be precision built to have a predetermined amount of vibration while rotating.

Each embodiment disclosed herein may be used or otherwise combined with any of the other embodiments disclosed. Any element of any embodiment may be used in any embodiment. Any of the above embodiments may be used alone or together with one another in any combination. Inventions encompassed within this specification may also include embodiments that are only partially mentioned or alluded to or are not mentioned or alluded to at all in the claims, title, and/or abstract of the invention.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
a leaf that is moveably suspended from a wall of the system;
a light source for illuminating the leaf when the light source is on;
a spring having a first end and a second end, the first end of the spring being attached to a motor, the second end of the spring being free; and
the motor for rotating the spring, wherein when the motor is on, the spring rotates, therein causing the leaf to vibrate, wherein the leaf is illuminated as the leaf vibrates.

2. The system of claim 1, wherein the leaf is mounted on a rod or wire in a manner allowing the leaf to move back and forth and swing from side to side.

3. The system of claim 2, wherein the rod or wire is mounted at an angle from parallel to a bottom surface of the system on which the system sits.

4. The system of claim 1, the system being configured, such that when turned on, the leaf temporarily looses contact with the spring.

5. The system of claim 1, wherein the leaf is suspended in a manner allowing the leaf to move back and forth and from side to side.

6. The system of claim 1, wherein when the motor is on, as the spring rotates, the second end of the spring at least temporarily contacts a bottom region of the leaf, causing the leaf to vibrate.

7. The system of claim 1, wherein the leaf is translucent, and light shines through the leaf when the light source is on.

8. The system of claim 1, wherein the leaf is reflective, and light is reflected by the leaf when the light source is on.

9. The system of claim 1, further comprising
a housing having a top edge, and
a lower region on one side of the top edge of the housing, wherein the leaf is visible through the concave.

10. The system of claim 9, wherein
the leaf has a front side and a back side, wherein the front side of the leaf faces the concave, and light shines on the back side of the leaf when the light source is on.

11. The system of claim 10, wherein
the housing includes structures that resemble an exterior wall of a partially used candle.

12. The system of claim 1, further comprising
a power source for providing electricity to the light source and the motor.

13. The system of claim 1, further comprising
a controller for automatically controlling the on and off of the motor and the light source.

14. The system of claim 1, wherein
the light source is an LED.

15. A system comprising:
an inner housing that includes
a leaf that is moveably suspended on a wire, the wire being mounted to a wall on the top of the inner housing;
a light source for illuminating the leaf when the light source is on, the light source being installed on the top of the inner housing;
a spring having a first end and a second end, the first end of the spring being attached to a shaft of a motor, the second end of the spring being free; and
the motor being attached in the inner housing for rotating the spring, wherein when the motor is on, the spring rotates, therein causing the leaf to vibrate, wherein the leaf is illuminated as the leaf vibrates;
a switch for turning on or off the system;
a control circuit for controlling the on-and-off of the motor and the light source;
one or more batteries for providing electricity to the system; and
an outer housing, the outer housing having a hole on the top of the outer housing, wherein the inner housing is inserted in the outer housing, the leaf sticking out of the hole on the top of the outer housing.

16. A method, comprising:
illuminating a leaf by a light source when the light source is on, the leaf being moveably suspended from a wall of the system;
rotating, by a motor when the motor is on, a spring that is attached to the motor on a first end, wherein a second end of the spring being free;
and
the rotation of the spring causing the leaf to vibrate, wherein the leaf is illuminated as the leaf vibrates.

17. The method of claim 16, further comprising
when the motor is on, as the spring rotates, the spring causes the leaf to vibrate.

18. The method of claim 16, further comprising
automatically controlling, by a controller, the on-and-off of the motor and the light source.

19. The method of claim 16, wherein the leaf temporarily looses contact with the spring.

20. A method, comprising
suspending a leaf from a wall of the system, the leaf being moveably;
providing a light source for illuminating the leaf when the light source is on;
attaching a first end of a spring to a motor, the motor being configured to rotate the spring when the motor is on, a second end of the spring being free; and
placing the motor below the leaf;
wherein when the motor is on, the spring rotates, therein causing the leaf to vibrate, wherein the leaf is illuminated as the leaf vibrates.

21. The method of claim 20, further comprising
mounting the leaf on a rod or wire in a manner allowing the leaf to move back and forth and from side to side.

22. The method of claim 20, further comprising
connecting a controller to the light source and the motor, wherein the controller automatically controls the on-and-off of the light source and the motor.
